(19) United States
(12) Patent Application Publication
(10) Pub. No.: US 2026/0230343 A1
(43) Pub. Date: Aug. 6, 2026

(54) SYSTEMS AND METHODS FOR PERFORMING ACTIONS BY AI ASSISTANTS THROUGH ACCESSING EXTERNAL SYSTEMS

(71) Applicant: Otter.ai, Inc., Mountain View, CA (US)

(72) Inventors: Yun Fu, Cupertino, CA (US); Richard Tasker, Sunnyvale, CA (US); Wen Sun, Sunnyvale, CA (US); Suraj Tripathi, Mountain View, CA (US); Xiaohan Wang, Santa Clara, CA (US); Shreyas Aiyar, Cupertino, CA (US)

(21) Appl. No.: 19/460,034

(22) Filed: Jan. 26, 2026

Related U.S. Application Data
(60) Provisional application No. 63/750,698, filed on Jan. 28, 2025.

(51) Int. Cl. H04L 12/18

(52) U.S. Cl. CPC H04L 12/1822; H04L 12/1818; H04L 12/1831

(57) ABSTRACT

Method and system for performing one or more actions by an AI agent system through accessing one or more external systems. For example, a method for performing one or more actions by an AI agent system through accessing one or more external systems, the AI agent system including an AI agent participant module and an AI agent platform, the AI agent platform including an agent knowledge store, an agent model, and an agent action module, the method comprising: joining, by the AI agent participant module, one or more meetings on one or more platforms with one or more human participants; receiving, by the AI agent participant module, one or more human communications from the one or more human participants during the one or more meetings on the one or more platforms.

### CROSS-REFERENCES TO RELATED APPLICATIONS

This application claims priority to U.S. Provisional Patent Application No. 63/750,698, filed Jan. 28, 2025, incorporated by reference herein for all purposes.

### TECHNICAL FIELD

Certain embodiments of the present disclosure relate to artificial intelligence (AI). More particularly, certain embodiments of the present disclosure relate to systems and methods for performing actions by AI assistants through accessing external systems.

### BACKGROUND

In today's fast-paced business environment, meetings often are integral for collaboration and decision-making. However, managing and extracting value from these meetings can be challenging due to information overload, diverse participant engagement levels, and/or the complexities of action item follow-ups.

Hence it is highly desirable to enhance meeting productivity.

### SUMMARY

Certain embodiments of the present disclosure relate to artificial intelligence (AI). More particularly, certain embodiments of the present disclosure relate to systems and methods for performing actions by AI assistants through accessing external systems.

According to certain embodiments, a method for performing one or more actions by an AI agent system through accessing one or more external systems, the AI agent system including an AI agent participant module and an AI agent platform, the AI agent platform including an agent knowledge store, an agent model, and an agent action module, the method comprising: joining, by the AI agent participant module, one or more meetings on one or more platforms with one or more human participants; receiving, by the AI agent participant module, one or more human communications from the one or more human participants during the one or more meetings on the one or more platforms; determining, by the AI agent participant module working with at least the agent model, whether or not one or more actions need to be performed by the AI agent system in response to the one or more human communications; receiving, from the agent model by the agent action module, information associated with the one or more actions if the one or more actions need to be performed by the AI agent system; determining, by the agent action module, one or more steps that need to be taken to complete the one or more actions based on at least the information associated with the one or more actions if the one or more actions need to be performed by the AI agent system; and accessing, by the agent action module, one or more external systems to perform the one or more steps to complete the one or more actions if the one or more steps include accessing the one or more external systems.

According to some embodiments, an AI agent system for performing one or more actions by accessing one or more external systems, the system comprising: an AI agent platform including an agent knowledge store, an agent model, and an agent action module; and an AI agent participant module coupled to the AI agent platform; wherein the AI agent participant module is configured to: join one or more meetings on one or more platforms with one or more human participants; receive one or more human communications from the one or more human participants during the one or more meetings on the one or more platforms; and work with at least the agent model to determine whether or not one or more actions need to be performed by the AI agent system in response to the one or more human communications; wherein the agent action module is configured to: receive, from the agent model, information associated with the one or more actions if the one or more actions need to be performed by the AI agent system; determine one or more steps that need to be taken to complete the one or more actions based on at least the information associated with the one or more actions if the one or more actions need to be performed by the AI agent system; and access one or more external systems to perform the one or more steps to complete the one or more actions if the one or more steps include accessing the one or more external systems; wherein the agent model includes a large language model.

According to certain embodiments, a non-transitory computer-readable medium storing instructions for performing one or more actions by an AI agent system through accessing one or more external systems, the instructions upon execution by one or more processors of a computing system, cause the computing system to perform one or more operations comprising: joining one or more meetings on one or more platforms with one or more human participants; receiving one or more human communications from the one or more human participants during the one or more meetings on the one or more platforms; determining whether or not one or more actions need to be performed by the AI agent system in response to the one or more human communications; receiving information associated with the one or more actions if the one or more actions need to be performed by the AI agent system; determining one or more steps that need to be taken to complete the one or more actions based on at least the information associated with the one or more actions if the one or more actions need to be performed by the AI agent system; and accessing one or more external systems to perform the one or more steps to complete the one or more actions if the one or more steps include accessing the one or more external systems.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a computer control, a human participant, and a system for an AI assistant (e.g., a system for an AI agent) according to certain embodiments of the present disclosure.

FIG. 2 is a simplified diagram showing two human participants and a system for an AI assistant (e.g., a system for an AI agent) according to certain embodiments of the present disclosure.

FIG. 3 is a simplified diagram showing a human participant, a system for an AI assistant (e.g., a system for an AI agent), and a third-party interface according to certain embodiments of the present disclosure.

FIG. 4 is a simplified diagram showing an AI assistant system (e.g., an AI agent system) according to certain embodiments of the present disclosure.

FIG. 5 is a simplified diagram showing a coaching method performed by the AI assistant system (e.g., an AI agent system) as shown in FIG. 4 according to some embodiments of the present disclosure.

FIG. 6 is a simplified diagram showing an AI assistant system (e.g., an AI agent system) according to certain embodiments of the present disclosure.

FIG. 7 is a simplified diagram showing a method performed by the AI assistant system (e.g., an AI agent system) as shown in FIG. 6 according to some embodiments of the present disclosure.

### DETAILED DESCRIPTION

Certain embodiments of the present disclosure relate to artificial intelligence (AI). More particularly, certain embodiments of the present disclosure relate to systems and methods for performing actions by AI assistants through accessing external systems.

According to some embodiments, there is a need for an intelligent system that not only transcribes and summarizes meetings but also actively participates, provides guidance, and/or performs tasks to enhance meeting productivity.

Certain embodiments of the present disclosure provide an AI assistant. For example, the AI assistant enhances real-time interaction during one or more meetings through one or more voice chat capabilities, provides coaching to one or more human participants (e.g., one or more users), exhibits agentic behaviors to perform one or more meeting-related tasks, and/or represents one or more persons (e.g., one or more users) through one or more avatars with comprehensive knowledge of the one or more persons'communications. As an example, the AI assistant leverages artificial intelligence to facilitate seamless communication, objective tracking, and/or proactive engagement, ultimately improving meeting outcomes and participant experience. Some embodiments of the present disclosure provide an AI assistant (e.g., an AI agent) with real-time interaction, coaching, agentic behavior, and/or avatar representation.

In some embodiments, an AI assistant (e.g., an AI agent) provides one or more multi-modal bi-directional interactions using text, voice, video, screen-share and/or screen-control to perform one or more tasks of the following tasks or all of the following tasks:
1. Live voice interaction according to certain embodiments. For example, the AI assistant allows one or more participants to ask one or more questions and/or retrieve information (e.g., in real-time) using one or more voice commands during the meeting. As an example, this facilitates immediate access to relevant data without interrupting the flow of discussion.
2. Contextual video playback according to some embodiments. For example, the AI assistance identifies and/or playbacks one or more videos to the one or more participants, wherein the one or more videos are relevant to the context of the conversation.
3. Dynamic product demo with live application control according to certain embodiments. For example, based on the conversation, the AI assistant initiates and/or controls one or more dynamic demonstrations of one or more products. As an example, the one or more dynamic demonstrations of the one or more products are customized to one or more needs of one or more participants.
4. Participant screen viewing and/or control according to some embodiments. For example, with one or more permissions, the AI assistant views one or more screens of one or more participants to, as an example, understand one or more actions of the one or more participants and/or provide real-time support and/or training.
5. Interruption handling according to some embodiments. For example, the AI assistant intelligently manages one or more interruptions by recognizing when one or more participants are speaking and/or by determining one or more optimal moments to interject an/or respond. As an example, the AI assistance ensures one or more smooth communication dynamics.
6. Pause and/or resume according to certain embodiments. For example, one or more participants pause one or more interventions of the AI assistant and/or one or more responses of the AI assistance. As an example, one or more participants resume one or more interventions of the AI assistant and/or one or more responses of the AI assistant (e.g., at the one or more participants'convenience), providing control over the AI assistant's engagement level.

In certain embodiments, a method 100 for an AI assistant (e.g., an AI agent) includes processes 101, 102, 103, 104, 105, 106, 107, 108, 109, 110, 111, 112, 113, 114, 115, 116, 117, 118, and/or 119. These processes are merely examples. One of ordinary skill in the art would recognize many variations, alternatives, and modifications. Although the above has been shown using a selected group of processes for the method 100, there can be many alternatives, modifications, and variations. For example, some of the processes may be expanded and/or combined. Other processes may be inserted into those noted above. Depending upon the embodiment, the sequence of processes may be interchanged with others replaced and/or skipped. Further details of these processes are found throughout the present disclosure.
Process 101: Join a meeting on a platform to conduct a spoken conversation with one or more human participants, wherein the spoken conversation includes one or more spoken human communications from the one or more human participants and also includes one or more spoken agent communications from an AI agent, according to some embodiments.
Process 102: During the meeting on the platform, receive one or more first spoken communications from the one or more human participants, according to some embodiments.
Process 103: In response to the one or more first spoken communications, retrieve pre-existing data relevant to the one or more first spoken communications, according to some embodiments.
Process 104: Based at least in part on the retrieved pre-existing data, present, on the platform, to the one or more human participants, one or more first spoken responses, according to some embodiments.
Process 105: During the meeting on the platform, receive one or more second spoken communications from the one or more human participants, according to some embodiments.
Process 106: In response to the one or more second spoken communications, retrieve one or more pre-existing videos relevant to the one or more second spoken communications, according to some embodiments.
Process 107: Play, during the meeting on the platform, the retrieved one or more pre-existing videos, according to some embodiments.
Process 108: When the retrieved one or more pre-existing videos are being played, receive, on the platform, one or more third spoken communications from the one or more human participants, according to some embodiments.
Process 109: In response to the one or more third spoken communications, stop playing the retrieved one or more pre-existing videos on the platform, according to some embodiments.
Process 110: During the meeting on the platform, receive one or more fourth spoken communications from the one or more human participants, according to some embodiments.
Process 111: In response to the one or more fourth spoken communications, start, on the platform, an interactive product demonstration relevant to the one or more fourth spoken communications, wherein the interactive product demonstration corresponds to multiple options, according to some embodiments.
Process 112: During the interactive product demonstration, receive, on the platform, one or more pieces of first spoken feedback from the one or more human participants, according to some embodiments.
Process 113: In response to the one or more pieces of first spoken feedback, select one option from the multiple options to continue the interactive product demonstration on the platform, according to some embodiments.
Process 114: During the meeting on the platform, receive one or more permissions from the one or more human participants, according to some embodiments.
Process 115: In response to the one or more permissions from the one or more human participants, view, on the platform, one or more screens of the one or more human participants to understand one or more actions of the one or more human participants and to also provide one or more pieces of second spoken feedback, according to some embodiments.
Process 116: During the meeting on the platform, receive one or more first commands from the one or more human participants, according to some embodiments.
Process 117: In response to the one or more first commands from the one or more human participants, pause conducting the spoken conversation with the one or more human participants, according to some embodiments.
Process 118: During the meeting on the platform, receive one or more second commands from the one or more human participants, according to some embodiments.
Process 119: In response to the one or more second commands from the one or more human participants, resume conducting the spoken conversation with the one or more human participants, according to some embodiments.

As discussed above and further emphasized here, the processes 101, 102, 103, 104, 105, 106, 107, 108, 109, 110, 111, 112, 113, 114, 115, 116, 117, 118, and/or 119 of the method 100 for an AI assistant (e.g., an AI agent) are merely examples. One of ordinary skill in the art would recognize many variations, alternatives, and modifications. In some examples, for the method 100, the processes 101, 102, 103, 104, 105, 106, 107, 108, 109, 110, 111, 112, 113, 114, 115, 116, 117, 118, and/or 119 are performed sequentially (e.g., from the process 101 through the process 119). In certain examples, for the method 100, the processes 101, 102, 103, 104, 105, 106, 107, 108, 109, 110, 111, 112, 113, 114, 115, 116, 117, 118, and/or 119 are not performed sequentially. In some examples, for the method 100, all processes of the processes 101, 102, 103, 104, 105, 106, 107, 108, 109, 110, 111, 112, 113, 114, 115, 116, 117, 118, and 119 are performed. In certain examples, for the method 100, one or more processes of the processes 101, 102, 103, 104, 105, 106, 107, 108, 109, 110, 111, 112, 113, 114, 115, 116, 117, 118, and 119 are performed, and one or more processes of the processes 101, 102, 103, 104, 105, 106, 107, 108, 109, 110, 111, 112, 113, 114, 115, 116, 117, 118, and 119 are skipped.

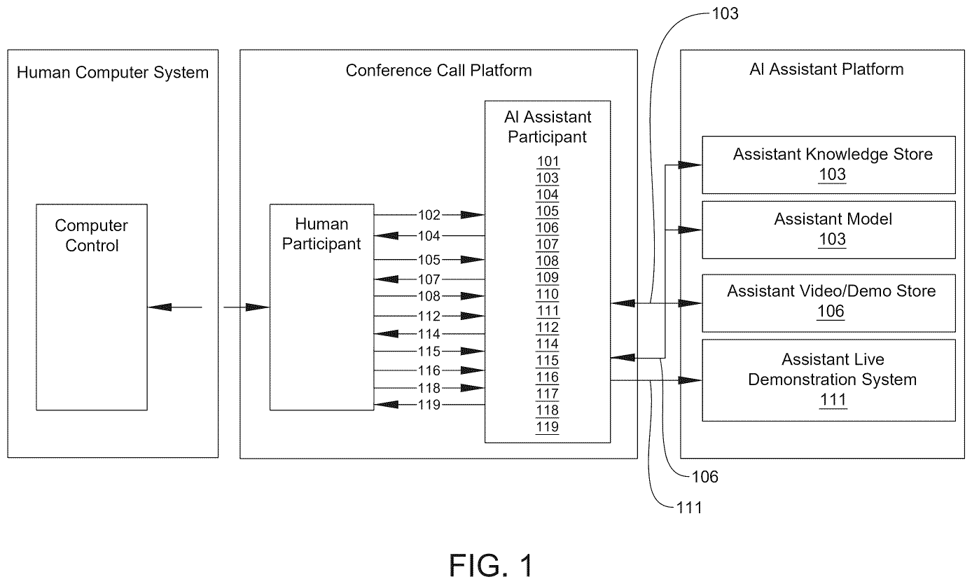

In some embodiments, some or all processes (e.g., steps) of the method 100 are performed by a system for an AI assistant. For example, as shown in FIG. 1, a system for an AI assistant includes an AI assistant platform and an AI assistant participant. In certain examples, some or all processes (e.g., steps) of the method 100 are performed by at least a computer and/or a processor directed by at least a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by at least a processor including a processor of a server computer and/or a processor of a client computer (e.g., a personal computer, and/or a server rack).

FIG. 1 is a simplified diagram showing a computer control, a human participant, and a system for an AI assistant (e.g., a system for an AI agent) according to certain embodiments of the present disclosure. This diagram is merely an example. One of ordinary skill in the art would recognize many variations, alternatives, and modifications. In some examples, the system for an AI assistant (e.g., a system for an AI agent) includes an AI assistant participant (e.g., an AI agent participant) and an AI assistant platform (e.g., an AI agent platform). In certain examples, the AI assistant platform (e.g., an AI agent platform) includes an assistant knowledge store (e.g., an agent knowledge store), an assistant model (e.g., an agent model), an assistant video and/or demo store (e.g., an agent video and/or demo store), and an assistant live demonstration system (e.g., an agent live demonstration system). For example, the computer control is a part of a human computer system as shown in FIG. 1. As an example, the human participant and the AI assistant participant (e.g., an AI agent participant) are parts of a conference call platform as shown in FIG. 1. For example, the computer control and the human participant interact with each other as shown FIG. 1.

According to some embodiments, as shown in FIG. 1, the numerals 101, 102, 103, 104, 105, 106, 107, 108, 109, 110, 111, 112, 114, 115, 116, 117, 118, and 119 represent the processes 101, 102, 103, 104, 105, 106, 107, 108, 109, 110, 111, 112, 114, 115, 116, 117, 118, and 119 respectively. Additionally, the process 113 is performed by the AI assistant participant and/or the assistant live demonstration system according to certain embodiments.

In some embodiments, an AI assistant (e.g., an AI agent) provides one or more coaching capabilities to perform one or more tasks of the following tasks or all of the following tasks:
1. Real-time objective tracking according to certain embodiments. For example, the AI assistant monitors one or more meetings'progress against one or more predetermined objectives. As an example, the AI assistant offers one or more insights and/or highlights one or more areas that need attention during one or more calls.
2. Guidance provision according to some embodiments. For example, the AI assistant suggests one or more pertinent questions to ask and/or suggests one or more responses to provide. As an example, the AI assistant aids one or more participants in steering one or more conversations effectively.
3. Lifecycle management of call objectives according to certain embodiments. For example, the AI assistant manages a full lifecycle of one or more meeting objectives to ensure continuity and/or alignment in one or more ongoing discussions. As an example, the full lifecycle includes determining the one or more meeting objectives and/or tracking the one or more meeting objectives across one or more calls.

In certain embodiments, a method 200 for an AI assistant (e.g., an AI agent) includes processes 201, 202, 203, 204, 205, 206, 207, 208, and/or 209. These processes are merely examples. One of ordinary skill in the art would recognize many variations, alternatives, and modifications. Although the above has been shown using a selected group of processes for the method 200, there can be many alternatives, modifications, and variations. For example, some of the processes may be expanded and/or combined. Other processes may be inserted into those noted above. Depending upon the embodiment, the sequence of processes may be interchanged with others replaced and/or skipped. Further details of these processes are found throughout the present disclosure.
Process 201: Receive one or more objectives of one or more first human participants for one or more meetings with one or more second human participants, according to some embodiments.
Process 202: Join the one or more meetings on one or more platforms with the one or more first human participants and the one or more second human participants, wherein, during the one or more meetings, the one or more first human participants and the one or more second human participants conduct one or more spoken conversations on the one or more platforms, the one or more spoken conversations include one or more first spoken communications from the one or more first human participants and/or the one or more second human participants and also include one or more second spoken communications from the one or more first human participants and/or the one or more second human participants, according to some embodiments.
Process 203: During the one or more meetings on the one or more platforms, receive the one or more first spoken communications from the one or more first human participants and/or the one or more second human participants, according to some embodiments.
Process 204: Based at least in part on the one or more first spoken communications from the one or more first human participants and/or the one or more second human participants, generate one or more pieces of first agent feedback, wherein the one or more pieces of first agent feedback include one or more agent questions and/or one or more agent responses, according to some embodiments.
Process 205: During the one or more meetings on the one or more platforms, present the one or more pieces of first agent feedback to the one or more first human participants, wherein the one or more first human participants use the one or more agent questions to generate one or more spoken questions to ask the one or more second participants and/or use the one or more agent responses to generate one or more spoken responses to present to the one or more second human participants, according to some embodiments.
Process 206: During the one or more meetings on the one or more platforms, receive the one or more second spoken communications from the one or more first human participants and/or the one or more second human participants, wherein the one or more second spoken communications include the one or more spoken questions and/or the one or more spoken responses, according to some embodiments.
Process 207: Based at least in part on the one or more first spoken communications and/or the one or more second spoken communications, determine whether at least one objective of the one or more objectives of the one or more first human participants has not yet been achieved, according to some embodiments.
Process 208: During the one or more meetings on the one or more platforms, if at least the objective of the one or more objectives of the one or more first human participants has not yet been achieved, generate one or more pieces of second agent feedback, wherein the one or more pieces of second agent feedback indicate at least the objective has not yet been achieved, according to some embodiments.
Process 209: During the one or more meetings on the one or more platforms, present the one or more pieces of second agent feedback to the one or more first human participants to remind the one or more first human participants at least the objective has not yet been achieved, according to some embodiments.

As discussed above and further emphasized here, the processes 201, 202, 203, 204, 205, 206, 207, 208, and/or 209 of the method 200 for an AI assistant (e.g., an AI agent) are merely examples. One of ordinary skill in the art would recognize many variations, alternatives, and modifications. In some examples, for the method 200, the processes 201, 202, 203, 204, 205, 206, 207, 208, and/or 209 are performed sequentially (e.g., from the process 201 through the process 209). In certain examples, for the method 200, the processes 201, 202, 203, 204, 205, 206, 207, 208, and/or 209 are not performed sequentially. In some examples, for the method 200, all processes of the processes 201, 202, 203, 204, 205, 206, 207, 208, and 209 are performed. In certain examples, for the method 200, one or more processes of the processes 201, 202, 203, 204, 205, 206, 207, 208, and 209 are performed, and one or more processes of the processes 201, 202, 203, 204, 205, 206, 207, 208, and 209 are skipped.

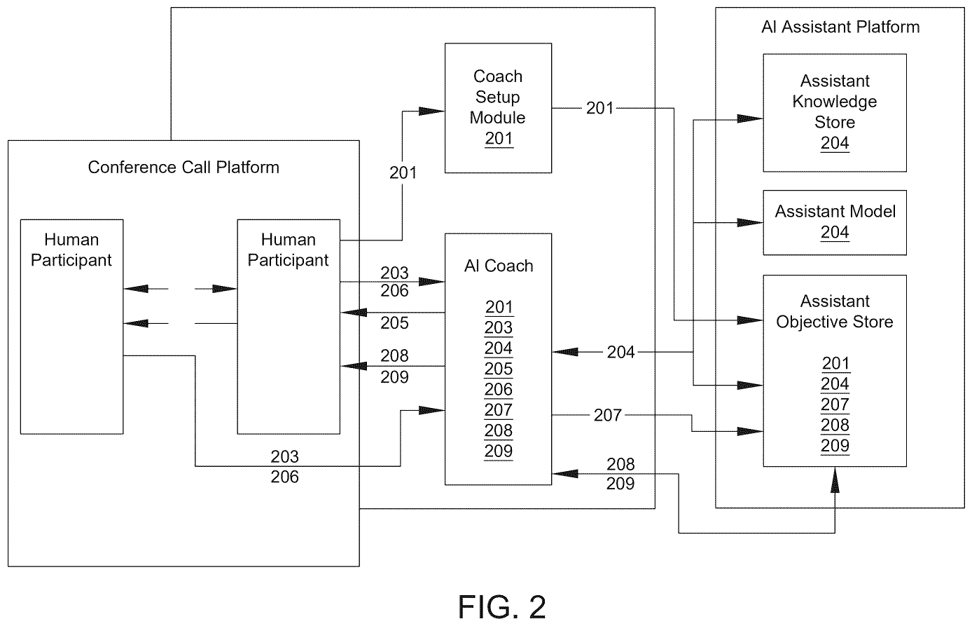

FIG. 2 is a simplified diagram showing two human participants and a system for an AI assistant (e.g., a system for an AI agent) according to certain embodiments of the present disclosure. This diagram is merely an example. One of ordinary skill in the art would recognize many variations, alternatives, and modifications. In some examples, the system for an AI assistant (e.g., a system for an AI agent) includes a coach setup module, an AI coach, and an AI assistant platform (e.g., an AI agent platform). In certain examples, the AI assistant platform (e.g., an AI agent platform) includes an assistant knowledge store (e.g., an agent knowledge store), an assistant model (e.g., an agent model), and an assistant objective store (e.g., an agent objective store). For example, the two human participants are parts of a conference call platform as shown in FIG. 2. As an example, the two human participants interact with each other as shown in FIG. 2.

According to some embodiments, as shown in FIG. 2, the numerals 201, 203, 204, 205, 206, 207, 208, and 209 represent the processes 201, 203, 204, 205, 206, 207, 208, and 209 respectively. Additionally, the process 202 is performed by the AI coach according to certain embodiments.

In some embodiments, an AI assistant (e.g., an AI agent) provides agentic behavior to perform one or more tasks of the following tasks or all of the following tasks:
1. One or more meeting-related actions according to certain embodiments. In certain examples, the one or more meeting-related actions include one or more actions of the following actions or all of the following actions:
   a. Task automation as one or more examples. For example, the AI assistant performs one or more actions such as scheduling one or more follow-up meetings, creating one or more action items, and/or capturing one or more agendas from one or more discussions.
   b. One or more third-party actions as one or more examples. For example, the AI assistant performs one or more actions on one or more third-party systems. As an example, the AI assistant leverages one or more user-level connections to the one or more third-party systems and/or leverages one or more workspace-level connections to the one or more third-party systems.
   c. Decision making as one or more examples. For example, the AI assistant autonomously decides when to speak, what to say, and/or what action to perform. As an example, the AI assistant autonomously makes one or more decisions to contribute effectively to one or more meetings.
2. Application control according to certain embodiments. For example, the AI assistant provides one or more modalities to interact with the AI assistant, via one or more voice commands and/or one or more text commands in one or more natural languages. As an example, the AI assistant provides one or more user interfaces to interact with the AI assistant.

In certain embodiments, a method 300 for an AI assistant (e.g., an AI agent) includes processes 301, 302, 303, 304, and/or 305. These processes are merely examples. One of ordinary skill in the art would recognize many variations, alternatives, and modifications. Although the above has been shown using a selected group of processes for the method 300, there can be many alternatives, modifications, and variations. For example, some of the processes may be expanded and/or combined. Other processes may be inserted into those noted above. Depending upon the embodiment, the sequence of processes may be interchanged with others replaced and/or skipped. Further details of these processes are found throughout the present disclosure.
Process 301: Join a meeting on a platform with one or more human participants, according to some embodiments.
Process 302: During the meeting on the platform, receive one or more spoken communications from the one or more human participants and/or one or more text communications from the one or more human participants, according to some embodiments.
Process 303: In response to the one or more spoken communications and/or the one or more text communications, determine whether an action should be performed by an AI agent, according to some embodiments.
Process 304: If the action should be performed by the AI agent, determine one or more steps that need to be taken in order to complete the action, wherein the one or more steps include accessing one or more external systems, according to some embodiments.
Process 305: Using one or more permissions granted to the one or more human participants of the meeting, access the one or more external systems to complete the one or more steps, according to some embodiments.

As discussed above and further emphasized here, the processes 301, 302, 303, 304, and/or 305 of the method 300 for an AI assistant (e.g., an AI agent) are merely examples. One of ordinary skill in the art would recognize many variations, alternatives, and modifications. In some examples, for the method 300, the processes 301, 302, 303, 304, and/or 305 are performed sequentially (e.g., from the process 301 through the process 305). In certain examples, for the method 300, the processes 301, 302, 303, 304, and/or 305 are not performed sequentially. In some examples, for the method 300, all processes of the processes 301, 302, 303, 304, and 305 are performed. In certain examples, for the method 300, one or more processes of the processes 301, 302, 303, 304, and 305 are performed, and one or more processes of the processes 301, 302, 303, 304, and 305 are skipped.

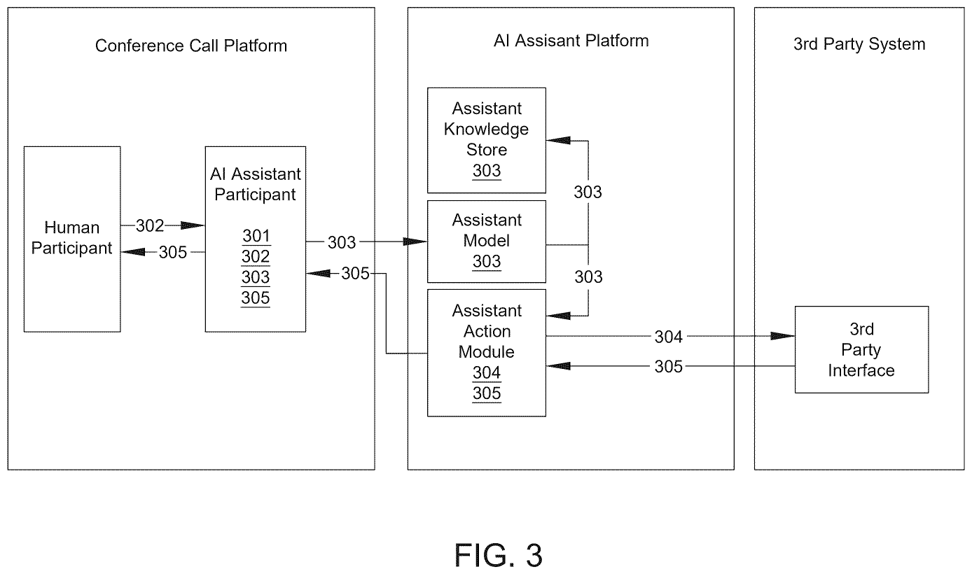

FIG. 3 is a simplified diagram showing a human participant, a system for an AI assistant (e.g., a system for an AI agent), and a third-party interface according to certain embodiments of the present disclosure. This diagram is merely an example. One of ordinary skill in the art would recognize many variations, alternatives, and modifications. In some examples, the system for an AI assistant (e.g., a system for an AI agent) includes an AI assistant participant (e.g., an AI agent participant) and an AI assistant platform (e.g., an AI agent platform). In certain examples, the AI assistant platform (e.g., an AI agent platform) includes an assistant knowledge store (e.g., an agent knowledge store), an assistant model (e.g., an agent model), and an assistant action module (e.g., an agent action module). For example, the human participant and the AI assistant participant (e.g., an AI agent participant) are parts of a conference call platform as shown in FIG. 3. As an example, the third-party interface is a part of a third-party system (e.g., an external system) as shown in FIG. 3. According to some embodiments, as shown in FIG. 3, the numerals 301, 302, 303, 304, and 305 represent the processes 301, 302, 303, 304, and 305 respectively.

In some embodiments, an AI assistant (e.g., an AI agent) serves as one or more specialized agents and/or one or more customized agents, wherein one or more tasks of the following tasks or all of the following tasks are performed:
1. Training on one or more existing calls according to certain embodiments. For example, the AI assistant is trained using data from one or more previous calls. As an example, the AI assistant is trained to understand one or more contexts and/or one or more objectives, enhancing effectiveness of the AI assistant in one or more various roles. For example, the AI assistant is trained to customize the interaction to reflect one or more cultures and/or one or more styles of one or more organizations.
2. One or more specialized agents according to certain embodiments. For example, the AI assistant functions as one or more agents of the following agents or all of the following agents:
   a. Sales agent as one or more examples.
   b. Customer support agent as one or more examples.
   c. Demand generation agent as one or more examples.
   d. Executive assistant agent as one or more examples.
   e. Onboarding agent as one or more examples.
   f. Recruiting agent as one or more examples.
   g. Meeting facilitator agent as one or more examples.

In certain embodiments, a method 400 for an AI assistant (e.g., an AI agent) includes processes 401 and/or 402. These processes are merely examples. One of ordinary skill in the art would recognize many variations, alternatives, and modifications. Although the above has been shown using a selected group of processes for the method 400, there can be many alternatives, modifications, and variations. For example, some of the processes may be expanded and/or combined. Other processes may be inserted into those noted above. Depending upon the embodiment, the sequence of processes may be interchanged with others replaced and/or skipped. Further details of these processes are found throughout the present disclosure.
Process 401: receive one or more recorded conversations conducted among one or more first human participants and one or more second human participants, wherein the one or more recorded conversations include one or more recorded first communications from the one or more first human participants and one or more recorded second communications from the one or more second human participants, and the one or more recorded second communications are generated by the one or more second human participants in response to the one or more recorded first communications, according to some embodiments.
Process 402: use the received one or more recorded conversations to train an AI agent to represent the one or more second human participants in one or more meetings, according to some embodiments.

As discussed above and further emphasized here, the processes 401 and/or 402 of the method 400 for an AI assistant (e.g., an AI agent) are merely examples. One of ordinary skill in the art would recognize many variations, alternatives, and modifications. In some examples, for the method 400, the processes 401 and 402 are performed sequentially (e.g., from the process 401 through the process 402). For example, for the method 400, both processes of the processes 401 and 402 are performed. In certain examples, for the method 400, one process of the processes 401 and 402 is performed, and the other process of the processes 401 and 402 is skipped.

In some embodiments, an AI assistant (e.g., an AI agent) provides avatar representation to perform one or more tasks of the following tasks or all of the following tasks:
1. User representation according to certain embodiments. For example, the AI assistant represents one or more persons in one or more meetings as one or more avatars. As an example, the AI assistant embodies one or more communication styles of the one or more persons and/or one or more preferences of the one or more persons.
2. Comprehensive knowledge integration according to certain embodiments. For example, the AI agent acts as an avatar of a person (e.g., a user) and has full access to the person's one or more past conversations, the person's one or more documents, and/or the person's one or more communications across one or more platforms (e.g., email and/or Slack). As an example, the AI agent participates proactively in a conversation as an avatar of the person.
3. Proactive participation according to some embodiments. For example, the AI agent acts as an avatar of a person (e.g., a user) and engages in one or more discussions on behalf of the person in the person's absence (e.g., by contributing one or more insights, answering one or more questions, and/or advancing one or more meeting objectives).

In certain embodiments, a method 500 for an AI assistant (e.g., an AI agent) includes processes 501, 502, 503, 504, and/or 505. These processes are merely examples. One of ordinary skill in the art would recognize many variations, alternatives, and modifications. Although the above has been shown using a selected group of processes for the method 500, there can be many alternatives, modifications, and variations. For example, some of the processes may be expanded and/or combined. Other processes may be inserted into those noted above. Depending upon the embodiment, the sequence of processes may be interchanged with others replaced and/or skipped. Further details of these processes are found throughout the present disclosure.
Process 501: receive one or more recorded conversations conducted between one or more first human participants and a second human participant, wherein the one or more recorded conversations include one or more recorded first communications from the one or more first human participants and one or more recorded second communications from the second human participant, and the one or more recorded second communications are generated by the second human participant in response to the one or more recorded first communications, according to some embodiments.
Process 502: use the received one or more recorded conversations to train an AI agent to learn one or more communication styles of the second human participant and one or more preferences of the second human participant, according to some embodiments.
Process 503: receive first information that has been received by the second human participant and second information that has been generated by the second human participant to gain knowledge of the second human participant, according to some embodiments.
Process 504: as an avatar of the second human participant, join a meeting on a platform to conduct a spoken conversation with one or more third human participants, wherein the spoken conversation includes one or more spoken human communications from the one or more third human participants and also includes one or more spoken avatar communications from the AI agent who is the avatar of the second human participant, according to some embodiments. For example, the one or more first human participants and the one or more third human participants share one or more common participants. As an example, the one or more first human participants and the one or more third human participants do not share any common participant.
Process 505: during the meeting on the platform, using the gained knowledge of the second human participant, generate the one or more spoken avatar communications based at least in part on the one or more communication styles of the second human participant and the one or more preferences of the second human participant, according to some embodiments.

As discussed above and further emphasized here, the processes 501, 502, 503, 504, and/or 505 of the method 500 for an AI assistant (e.g., an AI agent) are merely examples. One of ordinary skill in the art would recognize many variations, alternatives, and modifications. In some examples, for the method 500, the processes 501, 502, 503, 504, and/or 505 are performed sequentially (e.g., from the process 501 through the process 505). In certain examples, for the method 500, the processes 501, 502, 503, 504, and/or 505 are not performed sequentially. In some examples, for the method 500, all processes of the processes 501, 502, 503, 504, and 505 are performed. In certain examples, for the method 500, one or more processes of the processes 501, 502, 503, 504, and 505 are performed, and one or more processes of the processes 501, 502, 503, 504, and 505 are skipped.

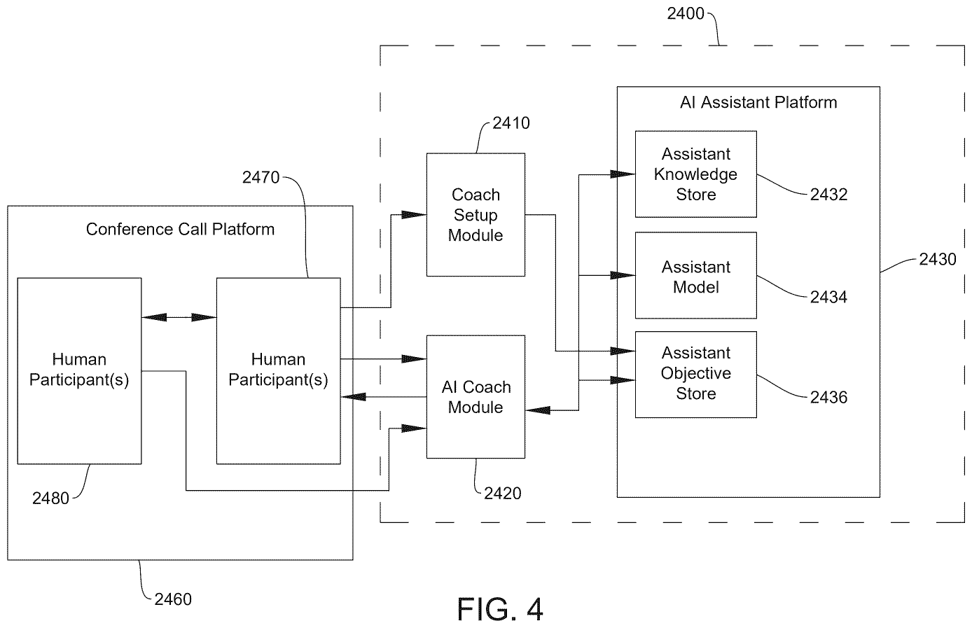

FIG. 4 is a simplified diagram showing an AI assistant system (e.g., an AI agent system) according to certain embodiments of the present disclosure. This diagram is merely an example. One of ordinary skill in the art would recognize many variations, alternatives, and modifications. The AI assistant system 2400 (e.g., an AI agent system) includes a coach setup module 2410, an AI coach module 2420, and an AI assistant platform 2430 (e.g., an AI agent platform). In some examples, the AI assistant platform 2430 (e.g., an AI agent platform) includes an assistant knowledge store 2432 (e.g., an agent knowledge store), an assistant model 2434 (e.g., an agent model), and an assistant objective store 2436 (e.g., an agent objective store). Although the above has been shown using a selected group of components for the AI assistant system 2400 (e.g., an AI agent system), there can be many alternatives, modifications, and variations. For example, some of the components may be expanded and/or combined. Other components may be inserted into those noted above. Depending upon the embodiments, the arrangement of components may be interchanged with others replaced. Further details of these components are found throughout the present disclosure.

As shown in FIG. 4, one or more human participants 2470 and one or more human participants 2480 participate in one or more meetings on a conference call platform 2460 according to some embodiments. For example, the one or more human participants 2470 interact with the one or more human participants 2480. As an example, the one or more human participants 2470 interact with the AI assistant system 2400 (e.g., an AI agent system). In some examples, the coach setup module 2410 is coupled to the AI assistant platform 2430 (e.g., an AI agent platform), and the AI coach module 2420 is also coupled to the AI assistant platform 2430 (e.g., an AI agent platform).

According to some embodiments, the AI assistant system 2400 (e.g., an AI agent system) provides one or more coaching capabilities to perform one or more tasks of the following tasks or all of the following tasks:
1. Real-time objective tracking according to certain embodiments. For example, the AI assistant system 2400 (e.g., an AI agent system) monitors one or more meetings'progress against one or more predetermined objectives. As an example, the AI assistant system 2400 (e.g., an AI agent system) offers one or more insights and/or highlights one or more areas that need attention during one or more calls.
2. Guidance provision according to some embodiments. For example, the AI assistant system 2400 (e.g., an AI agent system) suggests one or more pertinent questions to ask and/or suggests one or more responses to provide. As an example, the AI assistant system 2400 (e.g., an AI agent system) aids one or more participants in steering one or more conversations effectively.
3. Lifecycle management of call objectives according to certain embodiments. For example, the AI assistant system 2400 (e.g., an AI agent system) manages a full lifecycle of one or more meeting objectives to ensure continuity and/or alignment in one or more ongoing discussions. As an example, the full lifecycle includes determining the one or more meeting objectives and/or tracking the one or more meeting objectives across one or more calls.

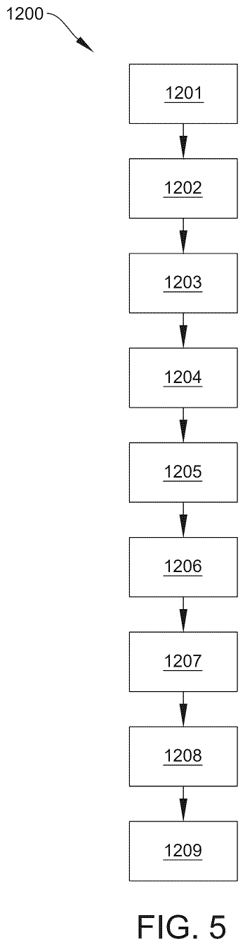

FIG. 5 is a simplified diagram showing a coaching method performed by the AI assistant system 2400 (e.g., an AI agent system) as shown in FIG. 4 according to some embodiments of the present disclosure. This diagram is merely an example. One of ordinary skill in the art would recognize many variations, alternatives, and modifications. The coaching method 1200 includes a process 1201 for receiving one or more objectives of one or more first human participants for one or more meetings with one or more second human participants, a process 1202 for joining the one or more meetings on one or more platforms with the one or more first human participants and the one or more second human participants, a process 1203 for receiving one or more first spoken communications from the one or more first human participants and/or the one or more second human participants during the one or more meetings on the one or more platforms, a process 1204 for generating one or more pieces of first agent feedback based at least in part on the one or more first spoken communications from the one or more first human participants and/or the one or more second human participants, a process 1205 for presenting the one or more pieces of first agent feedback to the one or more first human participants during the one or more meetings on the one or more platforms, a process 1206 for receiving one or more second spoken communications from the one or more first human participants and/or the one or more second human participants during the one or more meetings on the one or more platforms, a process 1207 for determining whether at least one objective of the one or more objectives of the one or more first human participants has not yet been achieved based at least in part on the one or more first spoken communications and/or the one or more second spoken communications, a process 1208 for generating one or more pieces of second agent feedback if at least the objective of the one or more objectives of the one or more first human participants has not yet been achieved during the one or more meetings on the one or more platforms, a process 1209 for presenting the one or more pieces of second agent feedback to the one or more first human participants during the one or more meetings on the one or more platforms. Although the above has been shown using a selected group of processes for the method 1200, there can be many alternatives, modifications, and variations. For example, some of the processes may be expanded and/or combined. Other processes may be inserted into those noted above. Depending upon the embodiment, the sequence of processes may be interchanged with others replaced and/or skipped. Further details of these processes are found throughout the present disclosure.

At the process 1201, the coach setup module 2410 receives one or more objectives of one or more first human participants (e.g., the one or more human participants 2470) for one or more meetings with one or more second human participants (e.g., the one or more human participants 2480) according to some embodiments. For example, the received one or more objectives of the one or more human participants 2470 are sent by the coach setup module 2410 to the assistant objective store 2436 (e.g., an agent objective store). As an example, the assistant objective store 2436 (e.g., an agent objective store) stores the one or more objectives of the one or more human participants 2470. In certain examples, the one or more objectives of the one or more human participants 2470 are sent from the assistant objective store 2436 (e.g., an agent objective store) to the AI coach module 2420.

At the process 1202, the AI coach module 2420 joins the one or more meetings on one or more platforms (e.g., the conference call platform 2460) with the one or more first human participants (e.g., the one or more human participants 2470) and the one or more second human participants (e.g., the one or more human participants 2480) according to certain embodiments. In some examples, the AI coach module 2420 joins, as an AI coach, the one or more meetings on the conference call platform 2460 with the one or more human participants 2470 and the one or more human participants 2480. In certain examples, during the one or more meetings, the one or more human participants 2470 and the one or more human participants 2480 conduct one or more spoken conversations on the conference call platform 2460. As an example, the one or more spoken conversations include one or more first spoken communications from the one or more human participants 2470 and/or the one or more human participants 2480 and also include one or more second spoken communications from the one or more human participants 2470 and/or the one or more human participants 2480.

At the process 1203, during the one or more meetings on the one or more platforms (e.g., the conference call platform 2460), the AI coach module 2420 receives the one or more first spoken communications from the one or more first human participants (e.g., the one or more human participants 2470) and/or the one or more second human participants (e.g., the one or more human participants 2480) according to some embodiments.

At the process 1204, based at least in part on the one or more first spoken communications from the one or more first human participants (e.g., the one or more human participants 2470) and/or the one or more second human participants (e.g., the one or more human participants 2480), the AI coach module 2420 generates one or more pieces of first agent feedback according to certain embodiments. For example, the one or more pieces of first agent feedback include one or more agent questions and/or one or more agent responses. In some examples, the AI coach module 2420 interacts with the assistant knowledge store 2432 (e.g., an agent knowledge store), the assistant model 2434 (e.g., an agent model), and/or the assistant objective store 2436 (e.g., an agent objective store) to generate the one or more pieces of first agent feedback. For example, the AI coach module 2420 uses at least knowledge stored in the assistant knowledge store 2432 (e.g., an agent knowledge store) and/or one or more objectives stored in the assistant objective store 2436 (e.g., an agent objective store) to generate the one or more pieces of first agent feedback. As an example, the AI coach module 2420 also uses at least the assistant model 2434 (e.g., an agent model) to generate the one or more pieces of first agent feedback, wherein the assistant model 2434 (e.g., an agent model) includes a large language model (LLM).

At the process 1205, during the one or more meetings on the one or more platforms (e.g., the conference call platform 2460), the AI coach module 2420 presents the one or more pieces of first agent feedback to the one or more first human participants (e.g., the one or more human participants 2470) according to some embodiments. For example, during the one or more meetings on the one or more platforms (e.g., the conference call platform 2460), the AI coach module 2420 presents the one or more agent questions and/or the one or more agent responses to the one or more first human participants (e.g., the one or more human participants 2470). As an example, during the one or more meetings on the one or more platforms (e.g., the conference call platform 2460), the one or more human participants 2470 use the one or more agent questions to generate one or more spoken questions to ask the one or more human participants 2480 and/or use the one or more agent responses to generate one or more spoken responses to present to the one or more human participants 2480.

At the process 1206, during the one or more meetings on the one or more platforms (e.g., the conference call platform 2460), the AI coach module 2420 receives the one or more second spoken communications from the one or more first human participants (e.g., the one or more human participants 2470) and/or the one or more second human participants (e.g., the one or more human participants 2480) according to certain embodiments. For example, the one or more second spoken communications include one or more spoken questions and/or one or more spoken responses.

At the process 1207, based at least in part on the one or more first spoken communications and/or the one or more second spoken communications, the AI coach module 2420 determines whether at least one objective of the one or more objectives of the one or more first human participants (e.g., the one or more human participants 2470) has not yet been achieved according to some embodiments. In certain examples, the AI coach module 2420 interacts with the assistant knowledge store 2432 (e.g., an agent knowledge store), the assistant model 2434 (e.g., an agent model), and/or the assistant objective store 2436 (e.g., an agent objective store) to determine whether at least one objective of the one or more objectives of the one or more human participants 2470 has not yet been achieved. For example, the AI coach module 2420 uses at least knowledge stored in the assistant knowledge store 2432 (e.g., an agent knowledge store) and/or one or more objectives stored in the assistant objective store 2436 (e.g., an agent objective store) to determine whether at least one objective of the one or more objectives of the one or more human participants 2470 has not yet been achieved. As an example, the AI coach module 2420 also uses at least the assistant model 2434 (e.g., an agent model) to determine whether at least one objective of the one or more objectives of the one or more human participants 2470 has not yet been achieved, wherein the assistant model 2434 (e.g., an agent model) includes a large language model (LLM). In some examples, if the AI coach module 2420 determines that at least one objective of the one or more objectives of the one or more first human participants (e.g., the one or more human participants 2470) has not yet been achieved, the process 1208 is performed. In certain examples, if the AI coach module 2420 determines that all of the one or more objectives of the one or more first human participants (e.g., the one or more human participants 2470) have been achieved, no other process is performed by the AI assistant system 2400 (e.g., an AI agent system).

At the process 1208, during the one or more meetings on the one or more platforms (e.g., the conference call platform 2460), if at least the objective of the one or more objectives of the one or more first human participants (e.g., the one or more human participants 2470) has not yet been achieved, the AI coach module 2420 generates one or more pieces of second agent feedback according to certain embodiments. For example, the one or more pieces of second agent feedback indicate that at least the objective has not yet been achieved. In some examples, the AI coach module 2420 interacts with the assistant model 2434 (e.g., an agent model) to generate the one or more pieces of second agent feedback. For example, the AI coach module 2420 uses at least the assistant model 2434 (e.g., an agent model) to generate the one or more pieces of second agent feedback, wherein the assistant model 2434 (e.g., an agent model) includes a large language model (LLM).

At the process 1209, during the one or more meetings on the one or more platforms (e.g., the conference call platform 2460), the AI coach module 2420 presents the one or more pieces of second agent feedback to the one or more first human participants (e.g., the one or more human participants 2470) to remind the one or more first human participants (e.g., the one or more human participants 2470) that at least the objective has not yet been achieved according to some embodiments.

As discussed above and further emphasized here, FIG. 5 is merely an example. One of ordinary skill in the art would recognize many variations, alternatives, and modifications. In some examples, for the method 1200, the processes 1201, 1202, 1203, 1204, 1205, 1206, 1207, 1208, and/or 1209 are performed sequentially (e.g., from the process 1201 through the process 1209). In certain examples, for the method 1200, the processes 1201, 1202, 1203, 1204, 1205, 1206, 1207, 1208, and/or 1209 are not performed sequentially. In some examples, for the method 1200, all processes of the processes 1201, 1202, 1203, 1204, 1205, 1206, 1207, 1208, and 1209 are performed. In certain examples, for the method 1200, one or more processes of the processes 1201, 1202, 1203, 1204, 1205, 1206, 1207, 1208, and 1209 are performed, and one or more processes of the processes 1201, 1202, 1203, 1204, 1205, 1206, 1207, 1208, and 1209 are skipped.

In some examples, if the AI coach module 2420 determines that all of the one or more objectives of the one or more first human participants (e.g., the one or more human participants 2470) have been achieved, the AI coach module 2420 generates one or more pieces of third agent feedback during the one or more meetings on the one or more platforms (e.g., the conference call platform 2460), and the AI coach module 2420 presents the one or more pieces of third agent feedback to the one or more first human participants (e.g., the one or more human participants 2470) during the one or more meetings on the one or more platforms (e.g., the conference call platform 2460), wherein the one or more pieces of third agent feedback indicate that all of the one or more objectives of the one or more first human participants (e.g., the one or more human participants 2470) have been achieved.

In some embodiments, some or all processes (e.g., steps) of the method 1200 are performed by the AI assistant system 2400 (e.g., an AI agent system). For example, as shown in FIG. 4, the AI assistant system 2400 (e.g., an AI agent system) includes the coach setup module 2410, the AI coach module 2420, and the AI assistant platform 2430 (e.g., an AI agent platform). In certain examples, some or all processes (e.g., steps) of the method 1200 are performed by at least a computer and/or a processor directed by at least a code. For example, a computer includes a server computer and/or a client computer (e.g., a personal computer). In some examples, some or all processes (e.g., steps) of the method 1200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by at least a processor including a processor of a server computer and/or a processor of a client computer (e.g., a personal computer, and/or a server rack).

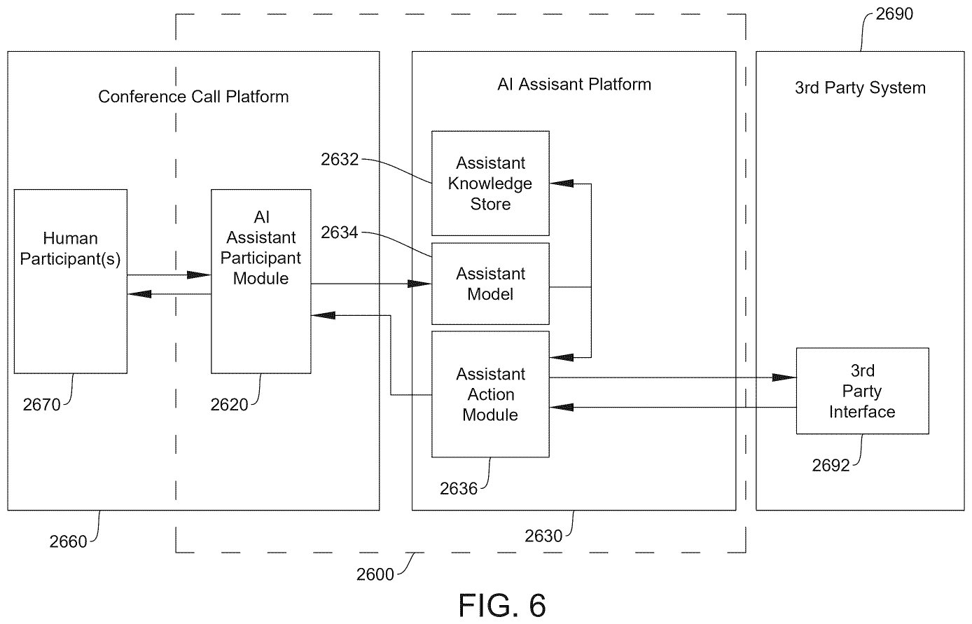

FIG. 6 is a simplified diagram showing an AI assistant system (e.g., an AI agent system) according to certain embodiments of the present disclosure. This diagram is merely an example. One of ordinary skill in the art would recognize many variations, alternatives, and modifications. The AI assistant system 2600 (e.g., an AI agent system) includes an AI assistant participant module 2620 (e.g., an AI agent participant module) and an AI assistant platform 2630 (e.g., an AI agent platform). In some examples, the AI assistant platform 2630 (e.g., an AI agent platform) includes an assistant knowledge store 2632 (e.g., an agent knowledge store), an assistant model 2634 (e.g., an agent model), and an assistant action module 2636 (e.g., an agent action module). Although the above has been shown using a selected group of components for the AI assistant system 2600 (e.g., an AI agent system), there can be many alternatives, modifications, and variations. For example, some of the components may be expanded and/or combined. Other components may be inserted into those noted above. Depending upon the embodiments, the arrangement of components may be interchanged with others replaced. Further details of these components are found throughout the present disclosure.

As shown in FIG. 6, one or more human participants 2670 and the AI assistant participant module 2620 (e.g., an AI agent participant module) participate in one or more meetings on a conference call platform 2660 according to some embodiments. For example, the one or more human participants 2670 interact with the AI assistant participant module 2620 (e.g., an AI agent participant module). In certain examples, the AI assistant participant module 2620 (e.g., an AI agent participant module) is coupled to the AI assistant platform 2630 (e.g., an AI agent platform). For example, the AI assistant participant module 2620 (e.g., an AI agent participant module) interacts with the AI assistant platform 2630 (e.g., an AI agent platform). In some examples, the AI assistant platform 2630 (e.g., an AI agent platform) is coupled to a third-party system 2690 (e.g., an external system) through a third-party interface 2692. For example, the third-party interface 2692 is a part of the third-party system 2690 (e.g., an external system). As an example, the AI assistant platform 2630 (e.g., an AI agent platform) interacts with the third-party system 2690 (e.g., an external system) through the third-party interface 2692. In certain examples, the AI assistant system 2600 (e.g., an AI agent system) is an AI agent system for performing one or more actions by accessing one or more external systems (e.g., the third-party system 2690).

In some embodiments, the AI assistant system 2600 (e.g., an AI agent system) provides agentic behavior to perform one or more tasks of the following tasks or all of the following tasks:
1. One or more meeting-related actions according to certain embodiments. In certain examples, the one or more meeting-related actions include one or more actions of the following actions or all of the following actions:
   a. Task automation as one or more examples. For example, the AI assistant system 2600 (e.g., an AI agent system) performs one or more actions such as scheduling one or more follow-up meetings, creating one or more action items, and/or capturing one or more agendas from one or more discussions.
   b. One or more third-party actions as one or more examples. For example, the AI assistant system 2600 (e.g., an AI agent system) performs one or more actions on the third-party system 2690 (e.g., an external system) through the third-party interface 2692. As an example, the AI assistant system 2600 (e.g., an AI agent system) leverages one or more user-level connections to the third-party system 2690 (e.g., an external system) through the third-party interface 2692 and/or leverages one or more workspace-level connections to the third-party system 2690 (e.g., an external system) through the third-party interface 2692.
   c. Decision making as one or more examples. For example, the AI assistant system 2600 (e.g., an AI agent system) autonomously decides when to speak, what to say, and/or what action to perform. As an example, the AI assistant system 2600 (e.g., an AI agent system) autonomously makes one or more decisions to contribute effectively to one or more meetings.
2. Application control according to certain embodiments. For example, the AI assistant system 2600 (e.g., an AI agent system) provides one or more modalities to interact with the AI assistant system 2600 (e.g., an AI agent system), via one or more voice commands and/or one or more text commands in one or more natural languages. As an example, the AI assistant system 2600 (e.g., an AI agent system) provides one or more user interfaces to interact with the AI assistant system 2600 (e.g., an AI agent system).

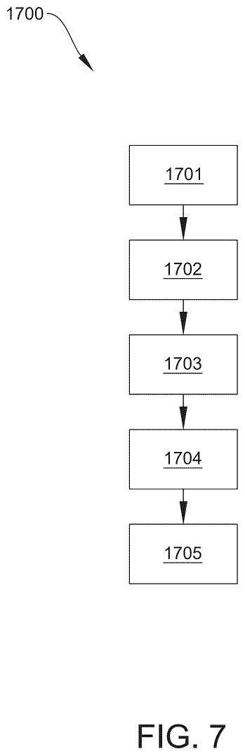

FIG. 7 is a simplified diagram showing a method performed by the AI assistant system 2600 (e.g., an AI agent system) as shown in FIG. 6 according to some embodiments of the present disclosure. This diagram is merely an example. One of ordinary skill in the art would recognize many variations, alternatives, and modifications. The method 1700 includes a process 1701 for joining one or more meetings on one or more platforms with one or more human participants, a process 1702 for receiving one or more spoken communications from the one or more human participants and/or one or more text communications from the one or more human participants, a process 1703 for determining whether or not one or more actions need to be performed by the AI assistant system 2600 (e.g., an AI agent system), a process 1704 for determining one or more steps that need to be taken in order to complete the one or more actions, and a process 1705 for accessing the one or more external systems to perform the determined one or more steps in order to complete the one or more actions. As an example, the method 1700 is a method for performing one or more actions by the AI assistant system 2600 (e.g., an AI agent system) through accessing one or more external systems (e.g., the third-party system 2690). Although the above has been shown using a selected group of processes for the method 1700, there can be many alternatives, modifications, and variations. For example, some of the processes may be expanded and/or combined. Other processes may be inserted into those noted above. Depending upon the embodiment, the sequence of processes may be interchanged with others replaced and/or skipped. Further details of these processes are found throughout the present disclosure.

At the process 1701, the AI assistant participant module 2620 (e.g., an AI agent participant module) joins one or more meetings on one or more platforms (e.g., the conference call platform 2660) with one or more human participants (e.g., the one or more human participants 2670) according to certain embodiments. In some examples, the AI assistant participant module 2620 (e.g., an AI agent participant module) joins, as an AI assistant participant (e.g., an AI agent participant), the one or more meetings on the one or more platforms (e.g., the conference call platform 2660) with the one or more human participants (e.g., the one or more human participants 2670). In certain examples, during the one or more meetings, the AI assistant participant module 2620 (e.g., an AI agent participant module) conducts, as an AI assistant participant (e.g., an AI agent participant), one or more conversations (e.g., one or more conversations in spoken and/or written forms) with the one or more human participants (e.g., the one or more human participants 2670) on the one or more platforms (e.g., the conference call platform 2660). For example, the one or more conversations (e.g., one or more conversations in spoken and/or written forms) include one or more spoken communications from the one or more human participants (e.g., the one or more human participants 2670) and/or one or more text communications from the one or more human participants (e.g., the one or more human participants 2670).

At the process 1702, during the one or more meetings on the one or more platforms (e.g., the conference call platform 2660), the AI assistant participant module 2620 (e.g., an AI agent participant module) receives, as an AI assistant participant (e.g., an AI agent participant), one or more human communications from the one or more human participants (e.g., the one or more human participants 2670) according to some embodiments. For example, the one or more human communications include one or more spoken communications from the one or more human participants (e.g., the one or more human participants 2670) and/or one or more text communications from the one or more human participants (e.g., the one or more human participants 2670).

At the process 1703, in response to the one or more spoken communications and/or the one or more text communications, the AI assistant participant module 2620 (e.g., the AI agent participant module) works with at least the assistant model 2634 (e.g., an agent model) to determine whether or not one or more actions need to be performed by the AI assistant system 2600 (e.g., an AI agent system) according to certain embodiments. In some examples, in response to the one or more spoken communications and/or the one or more text communications, the AI assistant participant module 2620 (e.g., the AI agent participant module) sends one or more messages (e.g., one or more instructions) to the assistant model 2634 (e.g., an agent model). For example, the assistant model 2634 (e.g., an agent model) receives the one or more messages (e.g., one or more instructions) and in response to the received one or more messages (e.g., one or more instructions), determines whether or not one or more actions need to be performed by the AI assistant system 2600 (e.g., an AI agent system). As an example, the assistant model 2634 (e.g., an agent model) includes a large language model (LLM). In certain examples, if the assistant model 2634 (e.g., an agent model) determines that one or more actions need to be performed by the AI assistant system 2600 (e.g., an AI agent system), the assistant model 2634 (e.g., an agent model) sends information associated with the one or more actions to the assistant knowledge store 2632 (e.g., an agent knowledge store) and the assistant action module 2636 (e.g., an agent action module). For example, the assistant knowledge store 2632 (e.g., an agent knowledge store) receives and stores the information associated with the one or more actions. As an example, the assistant action module 2636 (e.g., an agent action module) receives the information associated with the one or more actions, and the assistant action module 2636 (e.g., an agent action module) determines one or more steps that need to be taken to complete the one or more actions based at least in part on the information associated with the one or more actions. In some examples, if the assistant model 2634 (e.g., an agent model) determines that one or more actions need to be performed by the AI assistant system 2600 (e.g., an AI agent system), the process 1704 is performed. In certain examples, if the assistant model 2634 (e.g., an agent model) determines that no action needs to be performed by the AI assistant system 2600 (e.g., an AI agent system), no other process is performed by the AI assistant system 2600 (e.g., an AI agent system).

At the process 1704, if the assistant model 2634 (e.g., an agent model) determines that one or more actions need to be performed by the AI assistant system 2600 (e.g., an AI agent system), the assistant action module 2636 (e.g., an agent action module), the assistant action module 2636 (e.g., an agent action module) receives information associated with the one or more actions from the assistant model 2634 (e.g., an agent model), and the assistant action module 2636 (e.g., an agent action module) determines one or more steps that need to be taken to complete the one or more actions based on at least the information associated with the one or more actions according to some embodiments. In certain examples, if the determined one or more steps do not include accessing any external systems (e.g., the third-party system 2690), the assistant action module 2636 (e.g., an agent action module) performs the determined one or more steps to complete the one or more actions. For example, after the determined one or more steps have been performed, the assistant action module 2636 (e.g., an agent action module) sends one or more messages to the AI assistant participant module 2620 (e.g., an AI agent participant module). As an example, the one or more messages that are sent by the assistant action module 2636 (e.g., an agent action module) to the AI assistant participant module 2620 (e.g., an AI agent participant module) include information associated with the one or more steps (e.g., one or more results of the performance of the one or more steps). In some examples, if the determined one or more steps include accessing one or more external systems (e.g., the third-party system 2690), the process 1705 is performed.

At the process 1705, if the determined one or more steps include accessing one or more external systems (e.g., the third-party system 2690), the assistant action module 2636 (e.g., an agent action module) accesses the one or more external systems (e.g., the third-party system 2690) to perform the determined one or more steps in order to complete the one or more actions according to some embodiments. For example, if the determined one or more steps include accessing one or more external systems (e.g., the third-party system 2690), the assistant action module 2636 (e.g., an agent action module) accesses the one or more external systems (e.g., the third-party system 2690) by using one or more permissions granted to the one or more human participants (e.g., the one or more human participants 2670) of the one or more meetings. As an example, the use of the one or more permissions that have been granted to the one or more human participants (e.g., the one or more human participants 2670) of the one or more meetings enables the assistant action module 2636 (e.g., an agent action module) to access the one or more external systems (e.g., the third-party system 2690) to perform the determined one or more steps. In certain examples, during the process 1705, if the determined one or more steps include accessing one or more external systems (e.g., the third-party system 2690), the assistant action module 2636 (e.g., an agent action module) interacts with the one or more external systems (e.g., the third-party system 2690) through one or more external interfaces (e.g., the third-party interface 2692), wherein the one or more external systems (e.g., the third-party system 2690) include the one or more external interfaces (e.g., the third-party interface 2692). For example, the assistant action module 2636 (e.g., an agent action module) sends one or more messages to the third-party system 2690 through the third-party interface 2692. As an example, the assistant action module 2636 (e.g., an agent action module) receives one or more messages from the third-party system 2690 through the third-party interface 2692. In some examples, if the determined one or more steps include accessing one or more external systems (e.g., the third-party system 2690), the assistant action module 2636 (e.g., an agent action module) performs the determined one or more steps to complete the one or more actions. For example, if the determined one or more steps include accessing one or more external systems (e.g., the third-party system 2690), the assistant action module 2636 (e.g., an agent action module) performs the determined one or more steps to complete the one or more actions by at least accessing the one or more external systems (e.g., the third-party system 2690). In certain examples, after the determined one or more steps have been performed, the assistant action module 2636 (e.g., an agent action module) sends one or more messages to the AI assistant participant module 2620 (e.g., an AI agent participant module). As an example, the one or more messages that are sent by the assistant action module 2636 (e.g., an agent action module) to the AI assistant participant module 2620 (e.g., an AI agent participant module) include information associated with the one or more steps (e.g., one or more results of the performance of the one or more steps).

As discussed above and further emphasized here, the processes 1701, 1702, 1703, 1704, and/or 1705 of the method 1700 for an AI assistant (e.g., an AI agent) are merely examples. One of ordinary skill in the art would recognize many variations, alternatives, and modifications. In some examples, for the method 1700, the processes 1701, 1702, 1703, 1704, and/or 1705 are performed sequentially (e.g., from the process 1701 through the process 1705). In certain examples, for the method 1700, the processes 1701, 1702, 1703, 1704, and/or 1705 are not performed sequentially. In certain examples, for the method 1700, all processes of the processes 1701, 1702, 1703, 1704, and 1705 are performed. In certain examples, for the method 1700, one or more processes of the processes 1701, 1702, 1703, 1704, and 1705 are performed, and one or more processes of the processes 1701, 1702, 1703, 1704, and 1705 are skipped. For example, the process 1705 is skipped. In some examples, if at the process 1703, the assistant model 2634 (e.g., an agent model) determines that no action needs to be performed by the AI assistant system 2600 (e.g., an AI agent system), the process 1702 is performed again.

In some embodiments, some or all processes (e.g., steps) of the method 1700 are performed by the AI assistant system 2600 (e.g., an AI agent system). For example, as shown in FIG. 6, the AI assistant system 2600 (e.g., an AI agent system) includes the AI assistant participant module 2620 (e.g., an AI agent participant module) and the AI assistant platform 2630 (e.g., an AI agent platform). In certain examples, some or all processes (e.g., steps) of the method 1700 are performed by at least a computer and/or a processor directed by at least a code. For example, a computer includes a server computer and/or a client computer (e.g., a personal computer). In some examples, some or all processes (e.g., steps) of the method 1700 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by at least a processor including a processor of a server computer and/or a processor of a client computer (e.g., a personal computer, and/or a server rack).

In certain embodiments, the method 100, the method 200, the method 300, the method 400, the method 500, the method 1200, and/or the method 1700 are combined. In some embodiments, components as shown in FIG. 1, components as shown in FIG. 2, components as shown in FIG. 3, components as shown in FIG. 4, and/or components as shown in FIG. 6 are combined. For example, the system for an AI assistant as shown in FIG. 1, the system for an AI assistant as shown in FIG. 2, the system for an AI assistant as shown in FIG. 3, the AI assistant system as shown in FIG. 4, and/or the AI assistant system as shown in FIG. 6 are combined. As an example, the method 400 is performed by at least the system for an AI assistant as shown in FIG. 1, the system for an AI assistant as shown in FIG. 2, the system for an AI assistant as shown in FIG. 3, the AI assistant system as shown in FIG. 4, and/or the AI assistant system as shown in FIG. 6.

In some embodiments, an intelligent meeting assistant system of an AI agent includes:
a. one or more voice chat modules enabling one or more real-time question and answer interactions during one or more meetings using one or more voice commands; and/or
b. one or more interruption handling mechanisms that manage the AI assistant's one or more interjections without disrupting one or more meeting flows; and/or
c. one or more coaching modules providing real-time objective tracking and/or providing guidance to one or more participants.

In certain embodiments, a method for agentic behavior of an AI assistant (e.g., in a meeting) includes:
a. training the AI assistant on one or more existing calls to determine one or more objectives; and/or
b. performing autonomously one or more actions (e.g., one or more meeting-related actions, such as scheduling one or more meetings and/or creating one or more action items); and/or
c. determining one or more moments (e.g., one or more optimal moments) to contribute to a conversation (e.g., the meeting).

In some embodiments, in an avatar-based representation system for one or more meetings, an AI assistant performs one or more actions of the following:
a. representing a person (e.g., a user) in the one or more meetings with access to one or more communication histories of the person; and/or
b. proactively participating in one or more discussions on behalf of the person (e.g., the user); and/or
c. integrating knowledge from one or more communication platforms to inform the AI assistant's participation.

Various embodiments of the present disclosure provide an interactive, intelligent, and/or autonomous meeting assistant (e.g., an AI agent). For example, the interactive, intelligent, and/or autonomous meeting assistant (e.g., the AI agent) supports one or more participants during one or more meetings. As an example, the interactive, intelligent, and/or autonomous meeting assistant (e.g., the AI agent) enhances productivity through proactive engagement and/or task automation. In some examples, by integrating voice chat, coaching, agentic behavior, and/or avatar representation, the interactive, intelligent, and/or autonomous meeting assistant (e.g., the AI agent) offers a comprehensive solution for one or more modern meeting challenges.

According to some embodiments, the method 100, the method 200, the method 300, the method 400, the method 500, the method 1200, and/or the method 1700 uses one or more computational models to perform one or more processes. In certain embodiments, a computational model includes a model to process data. In some embodiments, a computational model includes, for example, an artificial intelligence (AI) model, a machine learning (ML) model, a deep learning (DL) model, an image processing model, an algorithm, a rule, other computational models, and/or a combination thereof. In certain embodiments, the method 100, the method 200, the method 300, the method 400, the method 500, the method 1200, and/or the method 1700 uses one or more machine learning models to perform one or more processes.

In some embodiments, the machine learning model is a language model (“LM”) that may include an algorithm, rule, model, and/or other programmatic instructions that can predict the probability of a sequence of words. In some embodiments, a language model may, given a starting text string (e.g., one or more words), predict the next word in the sequence. In certain embodiments, a language model may calculate the probability of different word combinations based on the patterns learned during training (based on a set of text data from books, articles, websites, audio files, etc.). In some embodiments, a language model may generate many combinations of one or more next words (and/or sentences) that are coherent and contextually relevant. In certain embodiments, a language model can be an artificial intelligence model that has been trained to understand, generate, and manipulate language. In some embodiments, a language model can be useful for natural language processing, including receiving natural language prompts and providing message responses based on the text on which the model is trained. In certain embodiments, a language model may include an n-gram, exponential, positional, neural network, and/or other type of model.

In certain embodiments, the machine learning model is a large language model (LLM), which was trained on a larger data set and has a larger number of parameters (e.g., millions of parameters). In certain embodiments, an LLM can understand complex textual inputs and generate coherent responses due to its extensive training. In certain embodiments, an LLM can use a transformer model that learns context and tracking relationships, and uses an attention mechanism. In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like.

According to some embodiments, a method for providing coaching by an AI agent system, the AI agent system including a coach setup module, an AI coach module, and an AI agent platform, the AI agent platform including an agent knowledge store, an agent model, and an agent objective store, the method comprising: receiving, by the coach setup module, one or more objectives of one or more first human participants for one or more meetings with one or more second human participants; sending, to the agent objective store by the coach setup module, the received one or more objectives of the one or more first human participants; storing, by the agent objective store, the one or more objectives of the one or more first human participants; sending, to the AI coach module by the agent objective store, the one or more objectives of the one or more first human participants; joining, by the AI coach module, the one or more meetings on one or more platforms with multiple human meeting participants, the multiple human meeting participants including the one or more first human participants and the one or more second human participants; receiving, by the AI coach module, one or more first spoken communications from at least one participant of the multiple human meeting participants during the one or more meetings on the one or more platforms; determining, by the AI coach module, whether at least one objective of the one or more objectives of the one or more first human participants has not yet been achieved based at least in part on the one or more first spoken communications; generating, by the AI coach module, one or more pieces of first agent feedback during the one or more meetings on the one or more platforms if at least the objective of the one or more objectives of the one or more first human participants has not yet been achieved, the one or more pieces of first agent feedback indicating at least the objective has not yet been achieved; and during the one or more meetings on the one or more platforms, presenting, by the AI coach module, the one or more pieces of first agent feedback to the one or more first human participants to remind the one or more first human participants that at least the objective has not yet been achieved. For example, the method is implemented according to at least FIG. 2. As an example, the method is implemented according to at least FIG. 4 and/or FIG. 5.

As an example, the one or more platforms include a conference call platform. For example, the joining, by the AI coach module, the one or more meetings on one or more platforms with multiple human meeting participants includes: joining, as an AI coach, the one or more meetings on the one or more platforms with the multiple human meeting participants. As an example, the one or more first spoken communications include one or more spoken questions and one or more spoken responses.

For example, the method further includes: receiving, by the AI coach module, one or more second spoken communications from at least one participant of the multiple human meeting participants during the one or more meetings on the one or more platforms. As an example, the method further includes: generating, by the AI coach module, one or more pieces of second agent feedback based at least in part on the one or more second spoken communications. For example, the method further includes: presenting, by the AI coach module, the one or more pieces of second agent feedback to the one or more first human participants during the one or more meetings on the one or more platforms.

As an example, the one or more pieces of second agent feedback include one or more agent questions. For example, the presenting, by the AI coach module, the one or more pieces of second agent feedback to the one or more first human participants includes: presenting the one or more agent questions to the one or more first human participants to generate one or more spoken questions to ask the one or more second human participants during the one or more meetings on the one or more platforms. As an example, the one or more pieces of second agent feedback include one or more agent responses. For example, the presenting, by the AI coach module, the one or more pieces of second agent feedback to the one or more first human participants includes: presenting the one or more agent responses to the one or more first human participants to generate one or more spoken responses to present to the one or more second human participants.

As an example, the generating, by the AI coach module, one or more pieces of second agent feedback based at least in part on the one or more second spoken communications includes: interacting, by the AI coach module, with the agent knowledge store, the agent model, and the agent objective store to generate the one or more pieces of second agent feedback. For example, the interacting, by the AI coach module, with the agent knowledge store, the agent model, and the agent objective store to generate the one or more pieces of second agent feedback includes: using, by the AI coach module, at least knowledge stored in the agent knowledge store and at least one objective of the one or more objectives stored in the agent objective store to generate the one or more pieces of second agent feedback. As an example, the interacting, by the AI coach module, with the agent knowledge store, the agent model, and the agent objective store to generate the one or more pieces of second agent feedback includes: using, by the AI coach module, at least the agent model to generate the one or more pieces of second agent feedback; wherein the agent model includes a large language model.

For example, the determining, by the AI coach module, whether at least one objective of the one or more objectives of the one or more first human participants has not yet been achieved includes: interacting, by the AI coach module, with the agent knowledge store, the agent model, and the agent objective store to determine whether at least one objective of the one or more objectives of the one or more first human participants has not yet been achieved.

As an example, the interacting, by the AI coach module, with the agent knowledge store, the agent model, and the agent objective store to determine whether at least one objective of the one or more objectives of the one or more first human participants has not yet been achieved includes: using, by the AI coach module, at least knowledge stored in the agent knowledge store and at least one objective of the one or more objectives stored in the agent objective store to determine whether at least one objective of the one or more objectives of the one or more first human participants has not yet been achieved. For example, the interacting, by the AI coach module, with the agent knowledge store, the agent model, and the agent objective store to determine whether at least one objective of the one or more objectives of the one or more first human participants has not yet been achieved includes: using, by the AI coach module, at least the agent model to determine whether at least one objective of the one or more objectives of the one or more first human participants has not yet been achieved; wherein the agent model includes a large language model. As an example, the generating, by the AI coach module, one or more pieces of first agent feedback during the one or more meetings on the one or more platforms if at least the objective of the one or more objectives of the one or more first human participants has not yet been achieved includes: using, by the AI coach module, at least the agent model to generate the one or more pieces of first agent feedback during the one or more meetings on the one or more platforms if at least the objective of the one or more objectives of the one or more first human participants has not yet been achieved; wherein the agent model includes a large language model.

According to certain embodiments, an AI agent system for providing coaching includes: an AI agent platform including an agent knowledge store, an agent model, and an agent objective store; a coach setup module coupled to the AI agent platform; and an AI coach module coupled to the AI agent platform; wherein the coach setup module is configured to: receive one or more objectives of one or more first human participants for one or more meetings with one or more second human participants; and send, to the agent objective store, the received one or more objectives of the one or more first human participants; wherein the agent objective store is configured to: store the one or more objectives of the one or more first human participants; and send, to the AI coach module, the one or more objectives of the one or more first human participants; wherein the AI coach module is configured to: join the one or more meetings on one or more platforms with multiple human meeting participants, the multiple human meeting participants including the one or more first human participants and the one or more second human participants; receive one or more first spoken communications from at least one participant of the multiple human meeting participants during the one or more meetings on the one or more platforms; determine whether at least one objective of the one or more objectives of the one or more first human participants has not yet been achieved based at least in part on the one or more first spoken communications; generate one or more pieces of first agent feedback during the one or more meetings on the one or more platforms if at least the objective of the one or more objectives of the one or more first human participants has not yet been achieved, the one or more pieces of first agent feedback indicating at least the objective has not yet been achieved; and during the one or more meetings on the one or more platforms, present the one or more pieces of first agent feedback to the one or more first human participants to remind the one or more first human participants that at least the objective has not yet been achieved. For example, the AI agent system is implemented according to at least FIG. 2. As an example, the AI agent system is implemented according to at least FIG. 4.

According to some embodiments, a non-transitory computer-readable medium storing instructions for providing coaching by an AI agent system, the instructions upon execution by one or more processors of a computing system, cause the computing system to perform one or more operations comprising: receiving one or more objectives of one or more first human participants for one or more meetings with one or more second human participants; sending the received one or more objectives of the one or more first human participants; storing the one or more objectives of the one or more first human participants; sending the stored one or more objectives of the one or more first human participants; joining the one or more meetings on one or more platforms with multiple human meeting participants, the multiple human meeting participants including the one or more first human participants and the one or more second human participants; receiving one or more first spoken communications from at least one participant of the multiple human meeting participants during the one or more meetings on the one or more platforms; determining whether at least one objective of the one or more objectives of the one or more first human participants has not yet been achieved based at least in part on the one or more first spoken communications; generating one or more pieces of first agent feedback during the one or more meetings on the one or more platforms if at least the objective of the one or more objectives of the one or more first human participants has not yet been achieved, the one or more pieces of first agent feedback indicating at least the objective has not yet been achieved; and during the one or more meetings on the one or more platforms, presenting the one or more pieces of first agent feedback to the one or more first human participants to remind the one or more first human participants that at least the objective has not yet been achieved. For example, the non-transitory computer-readable medium is implemented according to at least FIG. 2. As an example, the non-transitory computer-readable medium is implemented according to at least FIG. 4 and/or FIG. 5.

According to certain embodiments, a method for performing one or more actions by an AI agent system through accessing one or more external systems, the AI agent system including an AI agent participant module and an AI agent platform, the AI agent platform including an agent knowledge store, an agent model, and an agent action module, the method comprising: joining, by the AI agent participant module, one or more meetings on one or more platforms with one or more human participants; receiving, by the AI agent participant module, one or more human communications from the one or more human participants during the one or more meetings on the one or more platforms; determining, by the AI agent participant module working with at least the agent model, whether or not one or more actions need to be performed by the AI agent system in response to the one or more human communications; receiving, from the agent model by the agent action module, information associated with the one or more actions if the one or more actions need to be performed by the AI agent system; determining, by the agent action module, one or more steps that need to be taken to complete the one or more actions based on at least the information associated with the one or more actions if the one or more actions need to be performed by the AI agent system; and accessing, by the agent action module, one or more external systems to perform the one or more steps to complete the one or more actions if the one or more steps include accessing the one or more external systems. For example, the method is implemented according to at least FIG. 3. As an example, the method is implemented according to at least FIG. 6 and/or FIG. 7.

As an example, the joining, by the AI agent participant module, one or more meetings on one or more platforms with one or more human participants includes: joining, as an AI agent participant, the one or more meetings on the one or more platforms with the one or more human participants. For example, the one or more platforms include a conference call platform. As an example, the one or more human communications include one or more spoken communications from the one or more human participants. For example, the one or more human communications include one or more text communications from the one or more human participants.

As an example, the determining, by the AI agent participant module working with at least the agent model, whether or not one or more actions need to be performed by the AI agent system in response to the one or more human communications includes: in response to the one or more human communications, sending, to the agent model by the AI agent participant module, one or more messages; receiving, by the agent model, the one or more messages; and in response to the received one or more messages, determining, by the agent model, whether or not one or more actions need to be performed by the AI agent system; wherein the agent model includes a large language model. For example, the one or more messages include one or more instructions.

As an example, the method further includes: if the one or more actions need to be performed by the AI agent system, sending, to the agent knowledge store and the agent action module by the agent model, information associated with the one or more actions. For example, the method further includes: storing, by the agent knowledge store, the information associated with the one or more actions. As an example, the method further includes: determining, by the agent action module, one or more steps that need to be taken to complete the one or more actions based at least in part on the information associated with the one or more actions.

For example, the accessing, by the agent action module, the one or more external systems to perform the one or more steps to complete the one or more actions if the one or more steps include accessing the one or more external systems includes: if the one or more steps include accessing the one or more external systems, using, by the agent action module, one or more permissions granted to the one or more human participants of the one or more meetings to enable the agent action module to access the one or more external systems. As an example, the accessing, by the agent action module, one or more external systems to perform the one or more steps to complete the one or more actions if the one or more steps include accessing the one or more external systems includes: interacting, by the agent action module, with the one or more external systems through one or more external interfaces if the one or more steps include accessing the one or more external systems; wherein the one or more external systems include the one or more external interfaces. For example, the interacting, by the agent action module, with the one or more external systems through one or more external interfaces if the one or more steps include accessing the one or more external systems includes: sending, by the agent action module, one or more first messages to the one or more external systems through the one or more external interfaces; and receiving, by the agent action module, one or more second messages from the one or more external systems through the one or more external interfaces.

As an example, the method further includes: performing, by the agent action module, the one or more steps that need to be taken to complete the one or more actions if the one or more actions need to be performed by the AI agent system. For example, the performing, by the agent action module, the one or more steps that need to be taken to complete the one or more actions if the one or more actions need to be performed by the AI agent system includes: the accessing, by the agent action module, one or more external systems to perform the one or more steps to complete the one or more actions if the one or more steps include accessing the one or more external systems. As an example, the method further includes: sending, to the AI agent participant module by the agent action module, one or more messages after the performing, by the agent action module, the one or more steps that need to be taken to complete the one or more actions if the one or more actions need to be performed by the AI agent system. For example, the one or more messages include one or more results of the performing, by the agent action module, the one or more steps that need to be taken to complete the one or more actions if the one or more actions need to be performed by the AI agent system. As an example, the agent model includes a large language model.

According to some embodiments, an AI agent system for performing one or more actions by accessing one or more external systems, the system comprising: an AI agent platform including an agent knowledge store, an agent model, and an agent action module; and an AI agent participant module coupled to the AI agent platform; wherein the AI agent participant module is configured to: join one or more meetings on one or more platforms with one or more human participants; receive one or more human communications from the one or more human participants during the one or more meetings on the one or more platforms; and work with at least the agent model to determine whether or not one or more actions need to be performed by the AI agent system in response to the one or more human communications; wherein the agent action module is configured to: receive, from the agent model, information associated with the one or more actions if the one or more actions need to be performed by the AI agent system; determine one or more steps that need to be taken to complete the one or more actions based on at least the information associated with the one or more actions if the one or more actions need to be performed by the AI agent system; and access one or more external systems to perform the one or more steps to complete the one or more actions if the one or more steps include accessing the one or more external systems; wherein the agent model includes a large language model. For example, the AI agent system is implemented according to at least FIG. 3. As an example, the AI agent system is implemented according to at least FIG. 6.

According to certain embodiments, a non-transitory computer-readable medium storing instructions for performing one or more actions by an AI agent system through accessing one or more external systems, the instructions upon execution by one or more processors of a computing system, cause the computing system to perform one or more operations comprising: joining one or more meetings on one or more platforms with one or more human participants; receiving one or more human communications from the one or more human participants during the one or more meetings on the one or more platforms; determining whether or not one or more actions need to be performed by the AI agent system in response to the one or more human communications; receiving information associated with the one or more actions if the one or more actions need to be performed by the AI agent system; determining one or more steps that need to be taken to complete the one or more actions based on at least the information associated with the one or more actions if the one or more actions need to be performed by the AI agent system; and accessing one or more external systems to perform the one or more steps to complete the one or more actions if the one or more steps include accessing the one or more external systems. For example, the non-transitory computer-readable medium is implemented according to at least FIG. 3. As an example, the non-transitory computer-readable medium is implemented according to at least FIG. 6 and/or FIG. 7.

Some embodiments provide an AI agent system to guide a junior salesperson in real time to perform tasks in a manner similar to a highly experienced salesperson. For example, an AI agent system provides live coaching during interactions (e.g., by suggesting one or more responses, one or more talking points, and/or one or more next steps) while also supporting long-term improvement through feedback, summaries, and/or patterns identified across past conversations. As an example, over time, an AI agent system allows skill transfer from experienced users to less experienced users, helping individuals improve performance, consistency, and/or outcomes without constant human supervision and/or manual training.

Certain embodiments provide a system for real-time coaching with user-configurable objectives, methodologies, and/or knowledge domains applicable to any professional context. Some embodiments provide a method for detecting semantic similarity between coaching suggestions to prevent repetitive guidance during live engagements. Certain embodiments provide a system for analyzing historical engagement transcripts to generate pre-engagement preparation summaries and/or dynamically update coaching objectives. Some embodiments provide a method for parallel multi-pipeline information synthesis combining factual retrieval, self-evaluation, and working memory for coaching generation.

Certain embodiments provide a method that includes: retrieving historical communications between first and second human participants; generating a pre-meeting summary based on the historical communications; and updating one or more objectives based on the historical communications. Some embodiments provide a method that includes: converting spoken communications into a semantic vector representation; querying a knowledge repository using the semantic vector representation; and incorporating retrieved knowledge into generated feedback.

According to certain embodiments, one or more platforms include a video conferencing platform, an audio conferencing platform, a voice communication platform, and/or a text-based communication platform. According to some embodiments, a process of joining, by an AI coach module, one or more meetings includes: joining the one or more meetings as a non-speaking participant configured to monitor communications without audibly participating in a conversation.

According to certain embodiments, a process of interacting, by an AI coach module, with an agent knowledge store, an agent model, and an agent objective store to generate one or more pieces of agent feedback includes: using, by the AI coach module, at least the agent model to generate the one or more pieces of agent feedback; wherein the agent model includes a generative artificial intelligence model configured to process natural language in text form, audio form, and/or visual form. According to some embodiments, a process of interacting, by an AI coach module, with an agent knowledge store, an agent model, and an agent objective store to determine whether at least one objective of one or more objectives of one or more human participants has not yet been achieved includes: using, by the AI coach module, at least the agent model to determine whether at least one objective has not yet been achieved; wherein the agent model includes a generative artificial intelligence model configured to process natural language in text form, audio form, and/or visual form. According to some embodiments, an agent model includes a generative artificial intelligence model configured to process text information, audio information, and/or visual information.

Certain embodiments provide a method that includes: prior to one or more meetings, retrieving, by an AI coach module, one or more historical communications between one or more first human participants and one or more second human participants from an agent knowledge store; generating, by the AI coach module, a summary of the one or more historical communications; and presenting, by the AI coach module, the summary to the one or more first human participants prior to the one or more meetings, wherein the method, for example, further includes: updating, by the AI coach module, one or more objectives stored in an agent objective store based at least in part on the one or more historical communications.

According to some embodiments, one or more objectives of one or more human participants are configurable, and the one or more objectives include: one or more communication style objectives specifying desired speaking patterns and/or phrasing; one or more technical knowledge objectives specifying subject matter to address; one or more methodology framework objectives specifying a structured approach to follow; and/or one or more outcome-based objectives specifying desired results of one or more meetings.

According to certain embodiments, one or more pieces of agent feedback include: one or more suggested questions for one or more human participants to ask; one or more suggested responses for the one or more human participants to provide; one or more factual information items relevant to one or more meetings; and/or one or more action items for the one or more human participants to complete, wherein a process of presenting the one or more pieces of agent feedback, for example, includes: displaying the one or more pieces of agent feedback in a structured visual format comprising one or more cards, each card corresponding to a distinct piece of agent feedback.

According to some embodiments, an AI agent system provides two autonomous agents (e.g., Agent J and Agent K) that interact with each other under different scenarios. For example, Agent J is configured to perform a specific role (e.g., sales development and/or recruiting), and Agent K is configured to simulate a realistic external counterpart (e.g., a potential customer and/or a job candidate), wherein Agent K interacts with Agent J autonomously to test Agent J's behavior, identifies strengths and gaps in Agent J's capabilities, and provides structured feedback, and over time, this feedback is used to continuously evaluate and improve Agent J's performance. As an example, Agent J represents a first entity (e.g., a company or individual A), and Agent K represents a second entity (e.g., a company or individual B), wherein the two agents interact and communicate with each other autonomously during a conversation on behalf of their respective entities, and each agent independently interprets the interaction, makes decisions during the conversation, and generates reports and/or insights that are sent back to its respective authority or owner.

According to certain embodiments, an AI agent provides one or more coaching capabilities to perform real-time objective tracking, wherein AI agent users have flexibility to provide additional objectives for different AI agent calls, and these additional objectives are also tracked along with global objectives. According to some embodiments, an AI agent provides one or more coaching capabilities to perform lifecycle management of call objectives. For example, for a sales development representative AI agent, there are multiple calls led by the AI agent where each call serves different purpose (e.g., one call focusing on understanding a prospect's needs and/or another call focusing on negotiation). As an example, for a recruiting AI agent, one call serves to understand one skill of a candidate, and another call serves to understand a different skill of the candidate. For example, an ML Engineer recruiting AI agent does a call to understand coding skills of a candidate and then another call to understand ML system design skills of the candidate.

In some embodiments, an AI agent provides agentic behavior to perform one or more actions, wherein the AI agent helps users perform meaningful actions on third-party platforms. For example, an AI agent drafts and sends emails based on voice and/or text instructions from users, and/or acts autonomously in response to AI-agent-to-AI-agent interactions and/or calls. As an example, an AI agent acting on behalf of a human salesperson integrates with external management systems to track prospects, update records, and/or manage ongoing sales activities. In certain embodiments, an AI agent is configured to serve as a centralized system for performing meaningful actions before, during, and/or after meetings. As an example, meaningful actions are carried out on one or more platforms of a centralized system and/or on one or more third-party platforms, providing users with flexibility while keeping workflows coordinated through, for example, a single AI-agent-driven system.

In certain embodiments, an AI agent provides one or more modalities to interact with the AI agent, wherein one or more users have flexibility to pre-configure the AI agent for one or more specific purposes. For example, a user pre-configures an AI agent that listens to calls, identifies a classification of meeting, and automatically performs certain actions in the background based on the classification. As an example, if an AI agent determines that a call is a customer support interaction, the AI agent generates a structured list of issues discussed and add these issues to a relevant management system. For example, AI agents are configured to assist users in different modes: by helping during a live call, by running a call autonomously on a user's behalf, and/or by performing predetermined actions before, during, and/or after the call completes.

In some embodiments, one or more AI agents serves as one or more specialized AI agents and/or one or more customized AI agents to preform training on one or more existing calls, wherein past human conversations serve as a knowledge base for the one or more AI agents to perform calls autonomously and/or provide live assistance to humans during a call. For example, the knowledge base through conversation changes over time so the knowledge base needs to be updated automatically as further calls are received. As an example, knowledge sources for the knowledge base include any communication platforms (e.g., email, documents, and/or drives).

In certain embodiments, an AI agent system supports different types of memory, each configured for different use cases. For example, AI agents maintain factual memory (e.g., specific details and/or data points), high-level and/or abstract memory (e.g., summaries, patterns, and/or long-term context), and/or other specialized forms of memory as needed. For example, supporting different types of memory allows AI agents to reason appropriately at different levels of detail and/or adapt their behavior based on both immediate context and/or long-term understanding.

According to certain embodiments, an AI agent embodies one or more communication styles of one or more persons and/or one or more preferences of the one or more persons, wherein the AI agent is configured to learn not only what information to convey but also how to communicate information by, for example, adapting tone, structure, and/or style based on the role the AI agent plays and context of interaction. For example, an AI agent representing a salesperson for an organization presents information in a persuasive and/or outcome-focused manner, while an AI agent tasked with resolving customer issues for the same organization communicates in a more empathetic and/or problem-solving style. As an example, role-aware communication allows an AI agent to behave more naturally and effectively across different scenarios.

Some embodiments provide a method for parallel execution of multiple specialized AI sub-agents to generate coordinated conversational responses in real-time. Certain embodiments provide a system for tracking token-level delivery status and excluding undelivered tokens from subsequent response generation context. Some embodiments provide a method for detecting semantic speech interruptions and coordinating cancellation of response generation and audio synthesis pipelines. Certain embodiments provide a method for routing response content to different output modalities based on embedded demarcation tags in generated text streams.

According to certain embodiments, one or more platforms include a video conferencing platform, an audio conferencing platform, a voice communication platform, and/or a text-based communication platform. According to some embodiments, one or more human communications include one or more visual communications from one or more human participants, wherein the one or more visual communications include one or more video feeds, screen sharing content, and/or one or more shared visual documents.

In certain embodiments, a process of determining, by an AI agent participant module working with at least an agent model, whether or not one or more actions need to be performed by an AI agent system in response to one or more human communications includes: in response to the one or more human communications, sending, to the agent model by the AI agent participant module, one or more inputs, the one or more inputs including text data, audio data, and/or video data; receiving, by the agent model, the one or more inputs; and in response to the received one or more inputs, determining, by the agent model, whether or not the one or more actions need to be performed by the AI agent system; wherein the agent model includes a generative artificial intelligence model configured to process text, audio, and/or visual information. For example, one or more inputs include video data, the video data including visual content shared by one or more human participants during one or more meetings, and an agent model is configured to analyze the visual content to determine whether one or more actions need to be performed. As an example, video data include a video feed of one or more human participants, a screen sharing presentation from the one or more human participants, and/or a shared visual document displayed during one or more meetings. For example, one or more inputs include contextual information, the context information including prior conversation history, user preferences, and/or meeting metadata.

In some embodiments, a method for performing one or more actions by an AI agent system through accessing one or more external systems, and the method comprising:
determining, by an agent action module, one or more steps that need to be taken to complete the one or more actions based at least in part on information associated with the one or more actions, wherein the determining, by an agent action module, one or more steps includes decomposing a complex action into a sequence of atomic operations, each atomic operation corresponding to a single interaction with an external system.

According to certain embodiments, one or more messages sent to an AI agent participant module include one or more results of performing one or more steps, the one or more results including success indicators, failure indicators, and/or data retrieved from one or more external systems. According to some embodiments, an agent model includes a generative artificial intelligence model, the generative artificial intelligence model including a large language model, an audio language model, and/or a multimodal language model. According to certain embodiments, an agent model includes a generative artificial intelligence model configured to process text, audio, and/or visual information.

In some embodiments, a process of determining, by an AI agent participant module working with at least an agent model, whether or not one or more actions need to be performed by an AI agent system in response to one or more human communications includes: generating, by a first processing unit, one or more initial responses to the one or more human communications; and concurrently determining, by a second processing unit, whether additional processing is needed to fully respond to the one or more human communications; wherein, for example, a method for performing the one or more actions by the AI agent system through accessing one or more external systems further includes: transmitting the one or more initial responses to one or more human participants while the second processing unit continues determining whether the additional processing is needed.

In certain embodiments, a method for performing one or more actions by an AI agent system through accessing one or more external systems includes: generating, by an AI agent participant module, one or more response portions in response to one or more human communications; assigning a delivery status to each response portion of the one or more response portions; and updating the delivery status of each response portion upon confirmation of delivery to one or more human participants, wherein, for example, the method for performing the one or more actions by the AI agent system through accessing the one or more external systems further includes: detecting an interruption from the one or more human participants during delivery of the one or more response portions; identifying one or more undelivered response portions based on the delivery status; and excluding the one or more undelivered response portions from subsequent responses to prevent repetition.

According to some embodiments, a method for performing one or more actions by an AI agent system through accessing one or more external systems includes: detecting, by an AI agent participant module, an interruption from one or more human participants during a first response generation; canceling one or more ongoing processes associated with the first response generation; and initiating a second response generation based on the interruption from the one or more human participants.

According to certain embodiments, a method for performing one or more actions by an AI agent system through accessing one or more external systems includes: generating, by an agent model, one or more responses containing both spoken content and displayed content; identifying which portions of the one or more responses are spoken content and which portions of the one or more responses are displayed content; and routing the spoken content to an audio output and routing the displayed content to a visual display.

In some embodiments, a computer-implemented method for operating a multi-modal autonomous AI agent in a video conferencing session, the method comprising:
a. Participant-Aware Initialization: Suppressing AI agent audio, visual, and demonstration output upon joining the session until detecting that a human participant has joined; upon detecting human participant presence, transmitting guidance messages informing the human participant how to interact with AI agent, and/or initiating coordinated AI agent output across audio, visual, and demonstration modalities, according to certain embodiments; and/or
b. State-Synchronized Visual Presence: Continuously monitoring audio output state and dynamically adjusting AI agent's visual representation to reflect whether the AI agent is currently speaking or listening; and/or upon transitions between speaking and listening states, reinitializing the visual representation to provide a natural indication that the AI agent's conversational state has changed, according to some embodiments; and/or
c. Sequential Audio-Video Coordination: When a video demonstration is requested while audio output is in progress, deferring initiation of the video demonstration until pending audio output has completed, thereby ensuring AI agent speech concludes before demonstration content begins; wherein participants are ensured to receive complete introductory content upon joining, observe visual feedback naturally correlated with AI agent speech, and experience synchronized transitions between speech and demonstration modes, according to certain embodiments.

In certain embodiments, AI agent's visual representation during speaking and listening states is derived from configurable assets that provide customization per AI agent or organization, and video demonstration is selected from a configurable library based on contextual parameters, wherein guidance messages inform participants of available interaction capabilities including requesting demonstrations and/or asking questions.

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, while the embodiments described above refer to particular features, the scope of the present disclosure also includes embodiments having different combinations of features and embodiments that do not include all of the described features. As an example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems'and methods'data (e.g., associations, mappings, data input, data output, intermediate data results, final data results) may be stored and implemented in one or more different types of computer-implemented data stores, such as different types of storage devices and programming constructs (e.g., SSD, RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods'operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A method for performing one or more actions by an AI agent system through accessing one or more external systems, the AI agent system including an AI agent participant module and an AI agent platform, the AI agent platform including an agent knowledge store, an agent model, and an agent action module, the method comprising:
joining, by the AI agent participant module, one or more meetings on one or more platforms with one or more human participants;
receiving, by the AI agent participant module, one or more human communications from the one or more human participants during the one or more meetings on the one or more platforms;
determining, by the AI agent participant module working with at least the agent model, whether or not one or more actions need to be performed by the AI agent system in response to the one or more human communications;
receiving, from the agent model by the agent action module, information associated with the one or more actions if the one or more actions need to be performed by the AI agent system;
determining, by the agent action module, one or more steps that need to be taken to complete the one or more actions based on at least the information associated with the one or more actions if the one or more actions need to be performed by the AI agent system; and
accessing, by the agent action module, one or more external systems to perform the one or more steps to complete the one or more actions if the one or more steps include accessing the one or more external systems.

2. The method of claim 1 wherein the joining, by the AI agent participant module, one or more meetings on one or more platforms with one or more human participants includes:
joining, as an AI agent participant, the one or more meetings on the one or more platforms with the one or more human participants.

3. The method of claim 1 wherein the one or more platforms include a conference call platform.

4. The method of claim 1 wherein the one or more human communications include one or more spoken communications from the one or more human participants.

5. The method of claim 1 wherein the one or more human communications include one or more text communications from the one or more human participants.

6. The method of claim 1 wherein the determining, by the AI agent participant module working with at least the agent model, whether or not one or more actions need to be performed by the AI agent system in response to the one or more human communications includes:
in response to the one or more human communications, sending, to the agent model by the AI agent participant module, one or more messages;
receiving, by the agent model, the one or more messages; and
in response to the received one or more messages, determining, by the agent model, whether or not one or more actions need to be performed by the AI agent system;
wherein the agent model includes a large language model.

7. The method of claim 6 wherein the one or more messages include one or more instructions.

8. The method of claim 1, and further comprising:
if the one or more actions need to be performed by the AI agent system, sending, to the agent knowledge store and the agent action module by the agent model, information associated with the one or more actions.

9. The method of claim 8, and further comprising:
storing, by the agent knowledge store, the information associated with the one or more actions.

10. The method of claim 8, and further comprising:
determining, by the agent action module, one or more steps that need to be taken to complete the one or more actions based at least in part on the information associated with the one or more actions.

11. The method of claim 1 wherein the accessing, by the agent action module, the one or more external systems to perform the one or more steps to complete the one or more actions if the one or more steps include accessing the one or more external systems includes:
if the one or more steps include accessing the one or more external systems, using, by the agent action module, one or more permissions granted to the one or more human participants of the one or more meetings to enable the agent action module to access the one or more external systems.

12. The method of claim 1 wherein the accessing, by the agent action module, one or more external systems to perform the one or more steps to complete the one or more actions if the one or more steps include accessing the one or more external systems includes:
interacting, by the agent action module, with the one or more external systems through one or more external interfaces if the one or more steps include accessing the one or more external systems;
wherein the one or more external systems include the one or more external interfaces.

13. The method of claim 12 wherein the interacting, by the agent action module, with the one or more external systems through one or more external interfaces if the one or more steps include accessing the one or more external systems includes:
sending, by the agent action module, one or more first messages to the one or more external systems through the one or more external interfaces; and
receiving, by the agent action module, one or more second messages from the one or more external systems through the one or more external interfaces.

14. The method of claim 1, and further comprising:
performing, by the agent action module, the one or more steps that need to be taken to complete the one or more actions if the one or more actions need to be performed by the AI agent system.

15. The method of claim 14 wherein the performing, by the agent action module, the one or more steps that need to be taken to complete the one or more actions if the one or more actions need to be performed by the AI agent system includes:
the accessing, by the agent action module, one or more external systems to perform the one or more steps to complete the one or more actions if the one or more steps include accessing the one or more external systems.

16. The method of claim 14, and further comprising:
sending, to the AI agent participant module by the agent action module, one or more messages after the performing, by the agent action module, the one or more steps that need to be taken to complete the one or more actions if the one or more actions need to be performed by the AI agent system.

17. The method of claim 16 wherein:
the one or more messages include one or more results of the performing, by the agent action module, the one or more steps that need to be taken to complete the one or more actions if the one or more actions need to be performed by the AI agent system.

18. The method of claim 1 wherein the agent model includes a large language model.

19. An AI agent system for performing one or more actions by accessing one or more external systems, the system comprising:
an AI agent platform including an agent knowledge store, an agent model, and an agent action module; and
an AI agent participant module coupled to the AI agent platform;
wherein the AI agent participant module is configured to:
join one or more meetings on one or more platforms with one or more human participants;
receive one or more human communications from the one or more human participants during the one or more meetings on the one or more platforms; and
work with at least the agent model to determine whether or not one or more actions need to be performed by the AI agent system in response to the one or more human communications;
wherein the agent action module is configured to:
receive, from the agent model, information associated with the one or more actions if the one or more actions need to be performed by the AI agent system;
determine one or more steps that need to be taken to complete the one or more actions based on at least the information associated with the one or more actions if the one or more actions need to be performed by the AI agent system; and
access one or more external systems to perform the one or more steps to complete the one or more actions if the one or more steps include accessing the one or more external systems;
wherein the agent model includes a large language model.

20. A non-transitory computer-readable medium storing instructions for performing one or more actions by an AI agent system through accessing one or more external systems, the instructions upon execution by one or more processors of a computing system, cause the computing system to perform one or more operations comprising:
joining one or more meetings on one or more platforms with one or more human participants;
receiving one or more human communications from the one or more human participants during the one or more meetings on the one or more platforms;
determining whether or not one or more actions need to be performed by the AI agent system in response to the one or more human communications;
receiving information associated with the one or more actions if the one or more actions need to be performed by the AI agent system;
determining one or more steps that need to be taken to complete the one or more actions based on at least the information associated with the one or more actions if the one or more actions need to be performed by the AI agent system; and
accessing one or more external systems to perform the one or more steps to complete the one or more actions if the one or more steps include accessing the one or more external systems.
